(19) United States
(12) Patent Application Publication
(10) Pub. No.: US 2011/0014550 A1
(43) Pub. Date: Jan. 20, 2011

(54) NANOSTRUCTURED MATERIAL LOADED WITH NOBLE METAL PARTICLES

(75) Inventors: San Ping Jiang, Singapore (SG); Xin Wang, Singapore (SG); Shuangyin Wang, Singapore (SG)

Correspondence Address: SEED INTELLECTUAL PROPERTY LAW GROUP PLLC, 701 FIFTH AVE, SUITE 5400, SEATTLE, WA, 98104, US

(73) Assignee: NANYANG TECHNOLOGICAL UNIVERSITY, Singapore (SG)

(21) Appl. No.: 12/808,162

(22) PCT Filed: Dec. 12, 2008
(86) PCT No.: PCT/SG08/00477

§ 371 Date: Sep. 13, 2010

Related U.S. Application Data
(60) Provisional application No. 61/013,909, filed on Dec. 14, 2007.

(51) Int. Cl. H01M 8/00; H01M 4/02

(52) U.S. Cl. 429/528; 429/535; 429/523; 429/532

(57) ABSTRACT

The present invention refers to a method of manufacturing a nanostructured material loaded with noble metal particles and a nanostructured material loaded with noble metal particles obtained by this method. The present invention further refers to an electrode for a fuel cell or a metal-hydride battery comprising a nanostructured material loaded with metal particles of the present invention and a method for manufacturing an electrode that can be used for the manufacture of a fuel cell or a metal-hydride battery.

### CROSS-REFERENCE TO RELATED APPLICATIONS

This application claims the benefit of priority of U.S. provisional application No. 61/013,909, filed Dec. 14, 2007, the contents of each being hereby incorporated by reference in its entirety for all purposes.

### FIELD OF THE INVENTION

The present invention refers to a method of manufacturing a nanostructured material loaded with noble metal particles and a nanostructured material loaded with noble metal particles obtained by this method. The present invention further refers to an electrode for a fuel cell or a metal-hydride battery comprising a nanostructured material loaded with metal particles of the present invention and a method for manufacturing an electrode that can be used for the manufacture of a fuel cell or a metal-hydride battery.

### BACKGROUND OF THE INVENTION

Polymer electrolyte membrane and direct methanol fuel cells (Proton exchange membrane fuel cells (PEMFCs) & direct-methanol fuel cells (DMFCs)) are a promising option for future energy needs (Winter, M., Brodd, R., 2004, J. Chem. Rev., vol. 104, pp. 4245). They provide a clean and mobile power source with high efficiency and low pollutant emissions (Service, R. F., 2002, Science, vol. 296, pp. 1222).

The basic chemical reactions involved in PEMFCs and DMFCs include hydrogen and methanol oxidation and oxygen reduction over precious metal catalysts, such as platinum, palladium or a platinum-ruthenium alloy, that are usually dispersed over a carbon support (Matsumoto, T., Komatsu, T., et al., 2004, J. Chem. Commun., pp. 840; Tu, H. C., Wang, W. L., 2006, J. Phys. Chem. B, vol. 110, pp. 15988). The poisoning of platinum catalyst by adsorbed CO intermediates as well as a low activity of the Pt catalyst are still thwarting the commercial applications of DMFCs and PEMFCs. A poor dispersion of Pt catalysts on the support is partially blamed for the low catalyst activity in DMFCs (Tang, H., Chen, J. H., 2005, Mater. Chem. Phys., vol. 92, pp. 548).

Carbon nanotubes (CNTs) with unique electrical and structural properties have attracted great interest in applications such as superconductivity, hydrogen storage, field emission, and heterogeneous catalysis (Ma, R. Z., Liang, J., et al., 1999, J. Power Sources, vol. 84, pp. 126; Dillon, A. C., Jones, K. M., et al., 1997, vol. 386, pp. 377). CNTs are widely studied as support for Pt and Pt alloy catalysts in fuel cells due to the high surface area, excellent electronic conductivity, and the high chemical stability. However, deposition, distribution, and size of Pt nanoparticles supported on CNTs are significantly affected by the synthesis method.

The activity of Pt nanoparticles is also significantly affected by the nature of their interaction with carbon nanotubes and the intrinsic properties of carbon nanotubes. Since carbon nanotubes are hydrophobic and chemically inert, it is necessary to activate the graphitic surface of the nanotubes for metal particles to adhere to them. Many research groups (Yu, R., Chen, L., 1998, Chem. Mater., vol. 10, pp. 718; Xing, Y., 2004, J. Phys. Chem. B, vol. 108, pp. 19255; Wang, L., Guo, S., et al., 2007, Electrochem. Comm., vol. 9, pp. 827) have reported that CNTs can be activated or functionalized for the deposition of nanoparticles by oxidative processes, e.g., refluxing CNTs in the mixture of nitric-sulfuric acid (HNO₃ and H₂SO₄), thus generating functional groups on the sidewalls and tube tips.

However, such harsh chemical oxidation treatment introduces a large number of defects and significantly damages the structure of CNTs, which leads to the loss of the electrical conductivity properties of CNTs and thus affecting the overall performance and stability of the electro catalytic activity of the Pt-CNTs for PEMFC and DMFCs.

Therefore, a need exists to provide methods for the manufacture of functionalized nanostructured materials which overcome at least some of the above mentioned problems.

### SUMMARY OF THE INVENTION

In a first aspect, the present invention refers to a method of manufacturing a nanostructured material loaded with noble metal particles, wherein the method includes:
reacting an unoxidized nanostructured material and a polyelectrolyte in a dispersion of the untreated nanostructured material and the polyelectrolyte;
dispersing the reacted nanostructured material obtained in the previous step and a noble metal precursor in a solution comprising a suitable reducing agent under conditions allowing reducing and depositing of the noble metal precursor on the reacted nanostructured material.

In another aspect, the present invention refers to a nanostructured material loaded with noble metal particles. This nanostructured material includes
a polyelectrolyte which is bound to the nanostructured material;
noble metal particles which are bound to the polyelectrolyte;
wherein the particles have a diameter between about 1 to 10 nm.

In another aspect, the present invention refers to a nanostructured material made of a carbon material covered with a layer of a noble metal or a metal oxide.

In a further aspect, the present invention refers to an electrode for a fuel cell or a metal-hydride battery comprising a nanostructured material of the present invention or a nanostructured material obtained by a method of the present invention.

In still another aspect, the present invention refers to a method of manufacturing an electrode comprising forming the nanostructured material obtained by a method of the present invention or a nanostructured material of the present invention.

In another aspect the present invention refers to a use of a nanostructured material obtained by a method of the present invention or a nanostructured material of the present invention for the manufacture of an electrode.

### BRIEF DESCRIPTION OF THE DRAWINGS

The invention will be better understood with reference to the detailed description when considered in conjunction with the non-limiting examples and the accompanying drawings, in which:

FIG. 1 illustrates the method of the present invention for the manufacture of a noble metal loaded nanostructured material. In a first step an unoxidized nanostructured material, such as a nanotube, is reacted with a polyelectrolyte. This polyelectrolyte is forming a layer around the nanostructured material providing primers (positively or negatively charged polymer groups) for the subsequent homogeneous deposition of noble metal precursors. During the reduction and deposition step nanoparticles form starting from the primers provided by the polyelectrolyte layer around the nanostructured material. At the end of this process a nanostructured material loaded with noble metal nanoparticles with an average size between about 1-10 nm or 1 to 5 nm or 1 to 3 nm is provided as indicated in the last image of FIG. 1.

FIG. 2 illustrates the experimental procedure of a specific example referred to herein showing the formation of noble metal nanosheath on MWCNTs. The insert is the chemical structure of PDDA (a), and it's contaminate (b). FIG. 2 illustrates that instead of directly coating a polymer coated nanotube with noble metals, such as platinum (precursor H₂PtCl₆), or palladium (precursor PdCl₂) or gold (precursor HAuCl₄) by using a reducing agent, in this case ascorbic acid (the way indicated on the left side of FIG. 2), it is desirable to first manufacture a nanostructured material loaded with metal nanoparticles according to the method of the present invention (pathway turning right in FIG. 2). Following the method of the present invention, at first the nanostructured material (such as CNT) coated with a polyelectrolyte (such as PDDA in FIG. 2) is reacted in a solution comprising a suitable reducing agent (such as ethylene glycole (EG) in FIG. 2) and a noble metal precursor (such as PtCl₆²⁻ in FIG. 2). After reduction of the noble metal precursor and deposition on the nanostructured material coated with the polyelectrolyte, the material thus obtained and shown at the outer right side in FIG. 2 is reacted in a solution also comprising a reducing agent (such as ascorbic acid (AA) in FIG. 2) and a noble metal precursor (such as H₂PtCl₆, PdCl₂ or HaAuCl₄ in FIG. 2) or a metal oxide. Their reaction results in a nanostructured material coated with a metal sheath (in FIG. 2 a Pt sheath) made of one of the noble metals or metal oxides added to the solution with the nanostructured material loaded with Pt nanoparticles. The Pt sheath is a contiguous layer formed by multiple nanoparticles. When however the nanostructured material coated with a polyelectrolyte is directed with a stronger reducing agent, such as ascorbic acid directly, without pre-deposition of noble metal nanoparticles at its surface as in the method of the present invention, no metal sheath forms at the surface of the nanostructured material coated with a polyelectrolyte. This example illustrates the importance of providing a nanostructured material loaded with nanoparticles first before trying to create a contiguous metal layer, or sheath in case of CNTs, at the surface of the nanostructured material. Without this intermediate step, the reaction, for example, of ascorbic acid and noble metal precursor results in the formation of nanoclusters of very big size. The size of nanoclusters is varying and generally lies between 10 nm to about 50 nm (indicated by the black stars in FIG. 2).

FIG. 3 shows TEM micrographs of (A) the Pt seeds deposited on PDDA-wrapped MWCNTs; (B) Pt nanosheaths on MWCNTs synthesized in the presence of Pt seeds; (C) HRTEM image of Pt nanoparticles in the Pt nanosheaths on MWCNTs synthesized in the presence of Pt seeds; and (D) Pt nanoclusters on MWCNTs synthesized in the absence of Pt seeds. The ionic functionalization of MWCNTs by coating with PDDA yields a large number of evenly distributed active sites (primers) on the MWCNT surfaces for anchoring anionic metal complexes and particles to the positively charged polymeric chains that results in homogeneously dispersed Pt crystallites (FIG. 3a). The distribution of Pt seeds on PDDA-MWCNTs is uniform and narrow and the average particle size is 2±0.75 nm (the inset in FIG. 3a). Such architecture proves ideal for the nucleation of contiguous, porous and crystalline noble metal nanosheaths (FIG. 3b). The Pt nanosheaths consist of Pt nanoparticles and the Pt crystallite size in the Pt nanosheaths is ˜3 nm (FIG. 3c). However, without the mediation of Pt seeds on the MWCNTs disconnected platinum aggregates form (FIG. 3d), as a result of solution nucleation and Ostwald ripening.

FIG. 4 shows TEM micrographs of Pt nanosheaths formed on MWCNTs synthesized in the presence of Pt seeds with different volume of added Pt precursors of (A) 3 mL, (B) 8 mL, and (C) 12 mL H₂PtCl₆. The concentration of H₂PtCl₆ was 10 mM. Thin Pt nanosheaths were formed on MWCNTs when 3 mL H₂PtCl₆ was used, and gradually thickened as the amount of salt increased to 12 mL. This corresponds to a Pt loading of 69.6%, 81.6%, 86 wt % synthesized with the addition of 3, 8 and 12 mL H₂PtCl₆ solution in the reactor. For the thick nanosheaths the MWCNTs are completely obscured in TEM images (FIG. 4c).

FIG. 5(A) shows a TEM micrograph of Pd nanosheaths on MWCNTs synthesized in the presence of Pt seeds, (B) shows a TEM micrograph of Pd nanoclusters on MWCNTs synthesized in the absence of Pt seeds, (C) shows a Pd element mapping of Pd nanosheaths, (D) shows a Pt element mapping of Pd nanosheaths, (E) shows a HRTEM micrograph of Pd nanosheaths at low magnification, and (F) shows a HRTEM micrograph of Pd nanosheaths at high magnification.

FIG. 6 shows the XRD patterns of (A) MWCNTs, (B) Pt nanosheaths on MWCNTs, and (C) Pd nanosheaths on MWCNTs.

FIG. 7 shows cyclic voltammetry curves (CVs) measured (A) in 0.5M H₂SO₄ solution and (B) in 0.5 M H₂SO₄+0.5M CH₃OH solution under a scan rate of 50 mV/s. The Pt electrocatalysts in the figure: (a) E-TEK Pt/C-50 wt %; (b) Pt nanosheath/MWCNTs-50 wt. %; (c) Pt nanosheath/MWCNTs-69.6%; (d) Pt nanosheaht/MWCNTs-81.6%; and (e) Pt nanosheath/MWCNTs-86%.

FIG. 8 shows the result of Raman spectroscopy which has been used to study the surface structure of unoxidized PDDA-wrapped MWCNTs and acid oxidized MWCNTs. As shown in FIG. 8, both MWCNTs have similar Raman scattering patterns. The Raman spectroscopy allows to determine the extent of the modification or defects in MWCNTs. The analysis of the Raman scattering patterns indicates that acid oxidation method caused more structural damage on MWCNTs which can decrease the electrical conductivity of MWCNTs and lower the corrosion resistance compared to polymer coated or wrapped nanostructured material.

FIG. 9(a) shows the TEM images of acid oxidized AO-MWCNTs loaded with 20 wt. % Pt. A poor dispersion of Pt nanoparticles on MWCNTs and a large number of aggregates can be seen. In contrast, in FIG. 9(b)-(e), showing Pt-PDDA-MWCNTs loaded with 10 wt. % Pt (b), 20 wt. % Pt (c), 30 wt. % Pt (d) and 40 wt. % Pt (e), Pt nanoparticles of smaller size (average size 2 nm vs 5 nm for Pt-AO-MWCNTs) were evenly deposited on the PDDA-MWCNTs. Even when the Pt loading is increased to 40%, a very uniform dispersion can still be obtained on the PDDA-MWCNTs and no or little agglomeration was observed. This shows that PDDA wrapped MWCNTs are much more effective supports than acid oxidized MWCNTs. In the case of AO-MWCNTs, the harsh acid oxidation condition also leads to the structural damage of MWCNTs, which would cause the loss in the electrical conductivity and thus potentially reduces the electro-catalytic activity of the catalyst.

FIG. 10(a) shows cyclic voltammograms (CVs) of Pt loaded MWCNTs in nitrogen saturated 0.5 M H₂SO₄. It can be seen that Pt-PDDA-MWCNTs exhibit higher electrochemically active surface area than Pt-AO-MWCNTs. This also demonstrates that the Pt deposited on PDDA wrapped MWCNTs are electrochemically accessible, which is very important, e.g., for fuel cell reactions. Using methanol electro-oxidation reaction as an example, the catalytic properties of Pt-PDDA-MWCNTs and Pt-AO-MWCNTs were characterized by CV in a nitrogen purged 0.5 M H₂SO₄+1.0 M CH₃OH solutions (see FIG. 10(b)). As shown in FIG. 10(b), the Faradaic current exhibits the well-known features of methanol oxidation on Pt based catalyst.

FIG. 11 shows the cyclic voltammetry curves of Pt catalysts supported on PDDA-MWNTs and commercial E-TEK Pt/C electrocatalysts on 0.5 M H₂SO₄+1.0 M CH₃OH under the same Pt loading of 0.02 mg/cm² at room temperature. From the results presented in FIG. 11 it can be seen that Pt-PDDA-MWCNTs electrocatalysts synthesized in the present invention show much higher electrocatalytic activity than that of commercial E-TEK Pt/C electrocatalysts.

FIG. 12 shows the TEM micrographs of Pd-PDDA-MWCNTs manufactured with and without mediation by NH₃. FIG. 12C shows the results of a control experiment. Pd/C-EG-NH₃ is a sample of Pd nanoparticles supported on carbon black using NH₃-mediated EG reduction.

FIG. 13 shows the TEM micrographs of Pd-PDDA-MWCNTs prepared by microwave assisted method using ethylene glycol as reducing agent. The average size of the Pd-nanoparticle is about 4 nm.

FIG. 14 shows the TEM images and corresponding energy dispersive detector (EDS) spectrum of PtRu-PDDA-MWCNTs nanoparticles.

FIG. 15 shows histograms illustrating the Pt nanoparticles size distribution on CNT. From this FIG. 15, one can see that the particle size distribution is very narrow; and although the average particle size slightly increases with the increase of Pt loading, the increase step is very small. For a Pt loading of Pt-PDDA-MWCNTs of 20 wt. % the average particle size is between about 1.25 nm to about 2.25 nm; for a loading rate of 40 wt. % the average particle size is between about 1.5 nm to about 2.5 nm; and for a loading rate of 60 wt. % the average particle size is between about 1.75 nm to about 2.75 nm.

FIG. 16 illustrates how much the metal particle size obtained by the present method can be reduced when using a microwave heating procedure. The microwave heating procedure can accelerate the reaction rate, which thus leads to smaller particle size, for example, as shown in FIG. 16. The average size of Pt particles shown in FIG. 16 is about 1.6 nm.

FIG. 17 shows TEM images of Pt loaded CNTs coated with one of the following polyelectrolytes: poly(diallyldimethylammonium chloride (PDDA) (Pt-PDDA-CNT in FIG. 17), poly(styrenesulfonic acid) (PSS) (Pt-PSS-CNT in FIG. 17), poly(acrylic acid) (PAA) (Pt-PAA-CNT in FIG. 17) and poly(allylaminehydrochloride) (PAH) (Pt-PAH-CNT in FIG. 17). From FIG. 17 it can be seen that the four different polyelectrolytes do not significantly affect the morphology of Pt/CNT composite.

FIG. 18 shows measurements of the electrochemical activity of the Pt loaded CNTs coated with different polyelectrolytes referred to in FIG. 17. As shown, the Faradaic current exhibits the well-known features of methanol oxidation on Pt based catalyst. As a kinetically controlled reaction, the activity of methanol oxidation on Pt can be represented by the magnitude of the anodic peak. The higher anodic current indicates a higher electro-catalytic activity on Pt/MWCNTs. The results show that all polyelectrolyte materials are suitable. However, PAA- and PSS-functionalized MWCNT as Pt support show much higher current density, compared with PDDA- and PAH-functionalized ones.

FIG. 19 shows UV-visible spectra (A) and differential UV-vis spectra (B) of (a) 1-AP, (b) 1-AP-functionalized MWCNTs, and (c) pristine MWCNTs.

FIG. 20 shows Raman spectroscopy curves of pristine MWCNTs, 1-APMWCNTs, and AO-MWCNTs.

FIG. 21 shows TEM images of PtRu nanoparticles supported on (a) AO-MWCNTs (PtRu/AO-MWCNTs), (b) 1-AP-MWCNTs (PtRu/1-AP-MWCNTs), and (c) carbon black (PtRu/C). The EDX spectum of PtRu/1-AP-MWCNTs is shown in panel d. The PtRu loading in PtRu/MWCNTs and PtRu/C electrocatalysts was 20 wt. %.

FIG. 22 shows TEM images and distribution histograms of PtRu nanoparticles on 1-AP-MWCNTs (a and b) and AO-MWCNTs (c and d). The PtRu loading was 40 wt %.

FIG. 23 shows XRD patterns of PtRu/AO-MWCNTs and PtRu/1-APMWCNTs.

FIG. 24 shows mass-normalized cyclic voltammograms of PtRu catalysts supported on 1-aminopyrene-MWCNTs, AO-MWCNTs, and carbon black with the 20 wt. % PtRu loading in (A) nitrogen-saturated 0.5 M H₂SO₄ and (B) nitrogen-saturated 0.5 M H₂SO₄+1.0 M CH₃OH at a scan rate of 50 mV/s and with the 40 wt. % PtRu loading in (C) nitrogen-saturated 0.5 M H₂SO₄ and (D) nitrogen-saturated 0.5 M H₂SO₄+1.0 M CH₃OH at a scan rate of 50 mV/s.

FIG. 25 demonstrates the stability of PtRu/1-AP-MWCNTs-40 wt. % and PtRu/AOMWCNTs-40 wt. % electrocatalysts in 0.5 M H₂SO₄+1.0 M CH₃OH. The potential scan was performed from -0.2 to 1.0 V vs Ag/AgCl and the scan rate was 50 mV/s.

### DETAILED DESCRIPTION OF THE PRESENT INVENTION

In a first aspect the present invention refers to a method of manufacturing a nanostructured material loaded with metal particles, wherein the method comprises:
reacting an unoxidized nanostructured material and a polyelectrolyte in a dispersion of the untreated nanostructured material and the polyelectrolyte;
dispersing the reacted nanostructured material obtained in the previous step and a noble metal precursor in a solution comprising a suitable reducing agent under conditions which allow reducing and depositing of the noble metal precursor or said metal oxide on the reacted nanostructured material.

The nanostructured material coated with metal particles obtained by this method is stable, the particle distribution on the nanostructured material is very uniform and shows a high density of particles on the nanostructured material. The high density/loading of particles on the nanostructured material does not show detrimental effects on the intrinsic properties of the nanostructured material, such as the electron conductivity and the thermal stability to name only a few.

The use of an “unoxidized” nanostructured material means that the nanostructured material has not been subjected to an oxidative treatment before reacting it with a polyelectrolyte. An oxidative treatment includes refluxing a treatment with a strong acid or oxidant, such as reflux in H₂SO₄/HNO₃ or KMnO₄ and H₂SO₄ to name only a few, subjecting the nanostructured material to an electrochemical treatment or reacting it with double bond-containing molecules, such as vinyl pyrrolidone or acrylic acid.

In one example, the term “unoxidized” refers to a nanostructured material which has not been subjected to an oxidative treatment and/or has not been functionalized before reacting the nanostructured material with the polyelectrolyte. “Functionalizing” means that a nanostructured material is treated to introduce functional groups at the surface of the nanostructured material. For example, the oxidation with an acid introduces —COOH groups at the surface of the nanostructured material. For example, a functionalization by silanization would introduce silane groups at the surface of the nanostructured material. Compounds used for silanisation can include for example aminosilanes, glycidoxysilanes and mercaptosilanes.

An oxidative treatment of the nanostructured material normally introduces a large number of defects and significantly damages the structure of the nanostructured material. This can lead to the loss of the electrical conductivity properties of the nanostructured material and can thus affect the overall performance and stability of the electrocatalytic activity of the metal particle loaded nanostructured material when used for example for fuel cells, such as PEMFCs and DMFCs.

It was found by the inventors that the use of an unoxidated nanostructured material does not only allows to avoid the formation of structural damages of the nanostructured material but also yields a higher density binding of polyelectrolytes on the surface of the nanostructured material. This again provides more active binding sited for the adsorption of metal particle precursors and deposition of metal particles on the surface of the nanostructured material. The adsorption and formation of more metal particles on the surface of the nanostructured material can be for example useful to improve the catalytic performance of such metal particle loaded nanostructured material when used as catalysts, such as in fuel cells and metal-hydride batteries.

The present invention uses nanostructured materials. Nanostructured materials can have any form and have usually dimensions typically ranging from 1 to 100 nm (where 10 angstrom=1 nm=1/1000 micrometer). More specific, a nanostructured material has at least one dimension being less than 100 nm. They can be classified into the following dimensional types: zero dimensional (OD) including nanospherical particles (also called nanoparticles or (nano)spheres); one dimensional (1D) including nanorods, nanowires (also called nanofibers) and nanotubes; two dimensional (2D) including nanoflakes, nanodiscs, nanocubes and nanofilms.

The nanostructured material which can be used in the present invention includes, but is not limited to spheres (nanoparticles), cubes, nanotubes, nanowires (also called nanofibers), nanorods, nanoflakes, nanodiscs, nanofilms and combinations of the aforementioned nanostructured materials in a mixture. In general, those nanostructured materials can be monodispersed, which means that the dispersion is uniform and no aggregation occurs and also that the size distribution is very narrow as will be illustrated further below. The nanotubes can be single-walled or double-walled or multi-walled nanotubes.

A nanostructured material can be made of any material. In one example, the nanostructured material can be made of a material which includes, but is not limited to carbon material, a ceramic, glass, such as soda-lime glass, borosilicate glass, acrylic glass, isinglass (Muscovy-glass), aluminium oxynitride; a metal, such as titanium; a metal oxide, a polypyrrole and mixtures of nanostructured materials made of different of the aforementioned substances. In one example, the nanostructured material is made of carbon material, such as activated carbon, carbon blacks or graphite.

The present invention uses a polyelectrolyte which is bound to the nanostructured material. According to the IUPAC definition, a “polyelectrolyte” is a polymer composed of macromolecules in which a substantial portion of the constitutional units contains ionic or ionizable groups, or both. In the context of the present invention, the term “polyelectrolyte” includes polycations and polyanions. The term “polycation” refers to a polyelectrolyte possessing net positive charge. While the polycation can contain monomer units that are charge positive, charge neutral, or charge negative, the net charge of the polymer is positive. The term “polyanion” refers to a polyelectrolyte containing a net negative charge. While the polyanion can contain monomer units that are charge negative, charge neutral, or charge positive, the net charge on the polymer is negative. For the method of the present invention one kind of polyelectrolyte or different kinds of polyelectrolytes can be used. Using different polyelectrolytes, such as different polycationic polyelectrolytes or different polyanionic polyelectrolytes or mixtures of polyanionic and polycationic polyelectrolytes would result in different coating structures on the nanostructured material.

Alternatively, a polyelectrolyte can be described in terms of the average charge per repeat unit in a polymer chain. For example, a copolymer composed of 100 neutral and 300 positively charged repeat units has an average charge of 0.75 (3 out of 4 units, on average, are positively charged). As another example, a polymer that has 100 neutral, 100 negatively charged, and 300 positively charged repeat units would have an average charge of 0.4 (100 negatively charged units cancel 100 positively charged units leaving 200 positively charged units out of a total of 500 units). Thus, a positively-charged polyelectrolyte has an average charge per repeat unit between 0 and 1 and a negatively-charged polyelectrolyte has an average charge per repeat unit between 0 and −1. An example of a positively-charged copolymer is PDDA-co-PAC (i.e., poly(diallyldimethylammonium chloride) and polyacrylamide copolymer) in which the PDDA units have a charge of 1 and the PAC units are neutral so the average charge per repeat unit is less than 1.

The charges on a polyelectrolyte may be derived directly from the monomer units or they may be introduced by chemical reactions on a precursor polymer. For example, PDDA is made by polymerizing diallyldimethylammonium chloride, a positively charged water soluble vinyl monomer. PDDA-co-PAC is made by the polymerization of a mixture of diallyldimethylammonium chloride and acrylamide (a neutral monomer which remains neutral in the polymer). Poly(styrenesulfonic acid) is often made by the sulfonation of neutral polystyrene. Poly(styrenesulfonic acid) can also be made by polymerizing the negatively charged styrene sulfonate monomer. The chemical modification of precursor polymers to produce charged polymers may be incomplete and typically result in an average charge per repeat unit that is less than 1. For example, if only about 80% of the styrene repeat units of polystyrene are sulfonated, the resulting poly(styrenesulfonic acid) has an average charge per repeat unit of about −0.8.

Examples of a negatively-charged polyelectrolyte include polyelectrolytes comprising a sulfonate group (SO₃⁻), such as poly(styrenesulfonic acid) (PSS), poly(2-acrylamido-2-methyl-1-propane sulfonic acid) (PAMPS), sulfonated poly (ether ether ketone) (SPEEK), sulfonated lignin, poly(ethylenesulfonic acid), poly(methacryloxyethylsulfonic acid), their salts, and copolymers thereof; polycarboxylates such as poly(acrylic acid) (PAA) and poly(methacrylic acid); and sulfates such as carrageenin.

Examples of a positively-charged polyelectrolyte include polyelectrolytes comprising a quaternary ammonium group, such as 1-aminopyrene (1-AP), poly(diallyldimethylammonium chloride) (PDDA), poly(vinylbenzyltrimethylammonium) (PVBTA), ionenes, poly(acryloxyethyltrimethyl ammonium chloride), poly(methacryloxy(2-hydroxy)propyltrimethyl ammonium chloride), and copolymers thereof; polyelectrolytes comprising a pyridinium group such as poly(N-methylvinylpyridinium) (PMVP), other poly(N-alkylvinylpyridines), and copolymers thereof; and protonated polyamines such as poly(allylaminehydrochloride) (PAH) and polyethyleneimine (PEI).

Further examples of oppositely-charged polyelectrolytes include charged biomacromolecules which are naturally occurring polyelectrolytes or their charged derivatives. A positively-charged biomacromolecule comprises a protonated sub-unit (e.g., protonated amines). Some negatively charged biomacromolecules comprise a deprotonated sub-unit (e.g., deprotonated carboxylates). Examples of biomacromolecules which may be charged for use in accordance with the present invention include proteins, polypeptides, enzymes, DNA, RNA, heparin, alginic acid, chondroitin sulfate, chitosan, chitosan sulfate, cellulose sulfate, polysaccharides, dextran sulfate and carboxymethylcellulose.

The molecular weight of synthetic polyelectrolyte molecules compared to natural occuring polyelectrolytes is typically about 1,000 to about 5,000,000 grams/mole, preferably about 10,000 to about 1,000,000 grams/mole. The molecular weight of naturally occurring polyelectrolyte molecules (i.e., biomolecules), however, can reach as high as 10,000,000 grams/mole. The polyelectrolyte typically comprises about 0.01% to about 40% by weight of a polyelectrolyte solution, and preferably about 0.1% to about 10% by weight.

Many of the foregoing polymers/polyelectrolytes, such as PDDA, exhibit some degree of branching. Branching may occur at random or at regular locations along the backbone of the polymer. Branching may also occur from a central point and in such a case the polymer is referred to as a “star” polymer, if generally linear strands of polymer emanate from the central point. If, however, branching continues to propagate away from the central point, the polymer is referred to as a “dendritic” polymer. Branched polyelectrolytes, including star polymers, comb polymers, graft polymers, and dendritic polymers, are also suitable for purposes of this invention.

In one example, the negatively-charged polyelectrolyte is selected from the group consisting of poly(styrenesulfonic acid) (PSS), poly(2-acrylamido-2-methyl-1-propane sulfonic acid), sulfonated lignin, poly(ethylenesulfonic acid), poly(methacryloxyethylsulfonic acid), sulfonated poly(ether ether ketone), and poly(acrylic acid) (PAA). In another example, the positively-charged polyelectrolyte is selected from the group consisting of poly(diallyldimethylammonium chloride) (PDDA), poly(vinylbenzyltrimethylammonium chloride), ionenes, poly(acryloxyethyltrimethyl ammonium chloride), poly(methacryloxy(2-hydroxy)propyltrimethyl ammonium chloride), poly(N-methylvinylpyridinium), other poly (N-alkylvinyl pyridiniums), a poly(N-aryl vinyl pyridinium) and poly(allylaminehydro chloride) (PAH).

In another example, the polyelectrolyte includes, but is not limited to poly(diallyldimethylammonium chloride (PDDA) (a), poly(styrenesulfonic acid) (PSS) (b), poly(acrylic acid) (PAA) (d) or poly(allylaminehydrochloride) (PAH) (c). Their formulas are illustrated in the following:

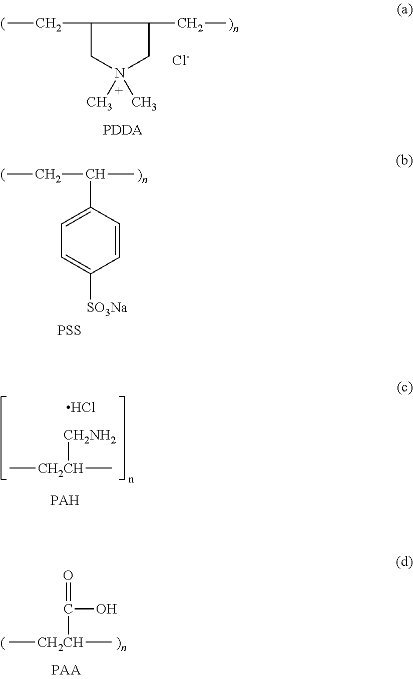

Reacting the nanostructured material with a polyelectrolyte as described above introduces functional groups (primers) in high density and homogenously distributed. The functional group introduced is either positively or negatively charged. The structure of the functional group depends on the polyelectrolyte used. For example, the functional group provided by a nanostructured material after reaction with PDDA is an ammonium group (NH₄⁺. The positive charge of the ammonium group interacts with the negative charge of the metal precursor. The functional group introduced when using PSS is a sulfite group (SO₃²⁻). The functional group introduced when using PAH is an ammonium group (NH₄⁺) and when using PAA it is a carboxylate group (—COO⁻). In case a polyelectrolyte providing negatively charged functional groups, such as PAA or PSS is used, the deposition of metal nanoparticles is due to the electrostatic interaction between the metal precursor and intrinsic functional groups of polyelectrolytes, such as PAA or PSS, because both, metal precursor and polyelectrolyte provide the same electrical charge. In case polyelectrolytes, such as PAA or PSS are used, metal nanoparticles are first reduced by the reducing agent, followed by the deposition on the nanostructured material due to the physical attraction, i.e. in those cases the functional negative group of polyelectrolytes, such as PAA or PSS function as active sites to support metal nanoparticles.

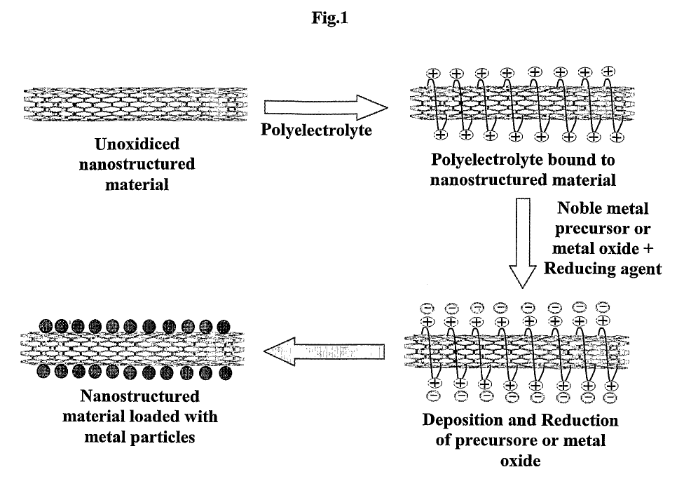

Thus, when looking at the chemical structure of the polyelectrolyte used, a person skilled in the art can easily determine what the specific functional group presented at the surface of the nanostructured material will be after reacting the nanostructured material with the polyelectrolyte. Yang, D.-Q., Rochette, J.-F., and Sacher, E. (2005, J. Phys. Chem. B, vol. 109, pp. 4481) describe that the interaction between a nanostructured material, such as a carbon nanotube and a polyelectrolyte, such as PDDA, is due to a π-π interaction and serves to coat or wrap the nanostructured material with a polyelectrolyte. Thus, on one side the polyelectrolyte is bound to the CNT via a π-π interaction (the binding is noncovalent) while on the other site the polyelectrolyte provides charged groups (primers) for the binding of noble metal precursors or metal oxides (see FIG. 1, second image in the flow chart).

The reaction between the polyelectrolyte and the nanostructured material can take place in an aqueous solution. In general, the choice of the media in which the reaction between the polyelectrolyte and the nanostructured material takes place depends on the polyelectrolyte used. Since polyelectrolytes are known in the art the skilled artisan can easily determine a suitable media. The nanostructured material can be dispersed in the aqueous solution before the addition of the polyelectrolyte or after the addition of a polyelectrolyte. In general, dispersing can be carried out by techniques known in the art, such as mixing or ultrasonication. Dispersing can be carried out between about 1 to 30 min, or 1 to 20 min or 1 to 10 min.

To influence the configuration of the polyelectrolyte which is to be bound to the nanostructured material, it is further possible to add an inorganic salt to the solution or dispersion of the nanostructured material and the polyelectrolyte. Influencing the configuration means to influence the density with which the polyelectrolyte is bound to the nanostructured material. For example, when reacting PDDA with a carbon nanotube, the addition of salt can allow the PDDA chain to adopt a random configuration, thus leading to a high coverage of PDDA chains on the carbon nanotube. An inorganic salt is usually administered in a concentration of below 1 wt. % or between 0.1 and 1 wt. % based on the total amount of the dispersion.

Any inorganic salt or metal salt or mixture of inorganic salt or metal salt can be used. Examples of inorganic salts include, but are not limited to NaCl, KCl, LiCl, MgCl₂, CaCl₂, CsCl, RbCl, KBr, KF, KI, CsBr, CsF, K₂CO₃, Na₂CO₃, Li₂CO₃ and, Na₂CrO₄.

After reacting the nanostructured material and the polyelectrolyte, the method further comprises removing the polyelectrolyte from the dispersion and isolating the reacted nanostructured material from the dispersion. The polyelectrolyte can be removed using standard methods, such as filtration and washing. Also, the nanostructured material which is now coated or wrapped with the polyelectrolyte is isolated from the dispersion by evaporating the solution in which the reaction of the polyelectrolyte and the nanostructured material took place. The process of heating the solution to obtain the dried product of the reaction between the polyelectrolyte and the nanostructured material can be accelerated by heating the solution under vacuum. The polymer wrapped nanostructured material is subsequently mixed or dispersed in a solution comprising a noble metal precursor and a reducing agent.

Therefore, in another aspect, the present invention refers to a method of manufacturing a metal loaded nanostructured material comprising:

dispersing a nanostructured material coated with a polyelectrolyte and a noble metal precursor in a solution comprising a suitable reducing agent under conditions to allow reducing and depositing of the noble metal precursor or the metal oxide on the reacted nanostructured material.

The noble metal precursor comprises a noble metal such as ruthenium, rhodium, gold, platinum, palladium, osmium, iridium and alloys of the aforementioned noble metals. Examples for such alloys include, but are not limited to the alloys are alloys of Au, or Pt, or Pd, or Cu, or In, or InSe, or PtRu or CuSe, or SnS₂ or mixtures thereof, or Ag₂Ni.

These noble metals are added to the solution as precursor. Examples for such precursors include, but are not limited to AgNO₃, [Ag(NH₃)₂]⁺ (aq), HAuCl₄.3H₂O, H₂PtCl₆.6H₂O, PdCl₂, K₂PdCl₄, RuCl₃, H₂PdCl₆.6H₂O or mixtures thereof. In one example a mixture of H₂PtCl₆.6H₂O and RuCl₃ has been used.

Suitable reducing agent in the context of the present invention means a reducing agent which allows or results in the formation of metal nanoparticles. The reducing agent used in the method of the present invention can include, but is not limited to ascorbic acid (AA), boranes, such as dimethylsulfide borane, decaborane, catecholborane or borane-tetrahydrofuran complex; copper hydride, citric acid, diisobutylaluminium hydride (DIBAL-H), diethyl 1,4-dihydro-2,6-dimethyl-3,5-pyridinedicarboxylate, ethanol, ethyleneglycol (EG), formaldehyde, formic acid, hydrazine, hydrogene, lithium aluminum hydride (LiAlH₄), 3-mercaptopropionic acid (3-MPA), methanol, nickel borohydride, silane, such as phenylsilane, tris(trimethylsilyl)silane (TTMSS), trichlorosilane, triethylsilane (TES), polymethylhydrosiloxane (PMHS) or polymethylhydrosiloxane; isopropanol (2-propanol), sodium bis(2-methoxyethoxy)aluminumhydride (Red-Al), sodium hydroxymethanesulfinate (Rongalite), sodium borohydride (NaBH₄), sodium cyanoborohydride, sodium dithionite (Na₂S₂O₄), sodium triacetoxyborohydride, tetramethyldisiloxane (TMDSO, TMDS), tributyltin hydride (tributylstannane), triphenylphosphine or triphenylphosphite. In one example, NaBH₄, ethylene glycol, ascorbic acid, formic acid, citric acid, ethanol, methanol or isopropanol can be used. In another example, a reducing agent can be a polyol, such as ethylene glycol.

For example, ethylene glycol is a suitable reducing agent due to its bifunctional role (reducing agent and stabilizer) during the synthesis of noble metal nanoparticles. Another example, is NaBH₄, which is a strong reducing agent leading to the fast nucleation which would generate a fine nanoparticle size.

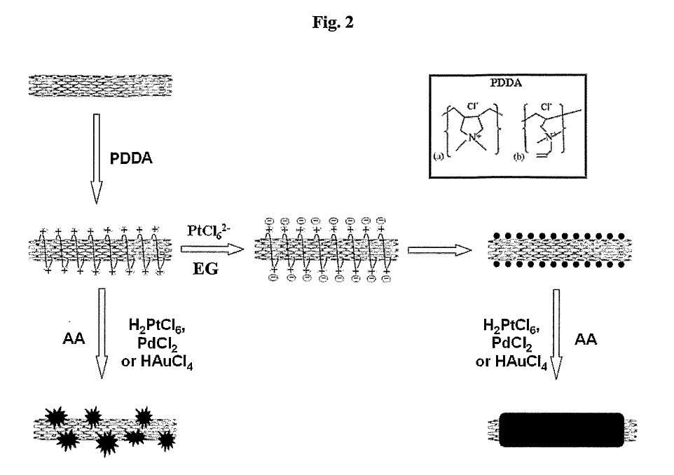

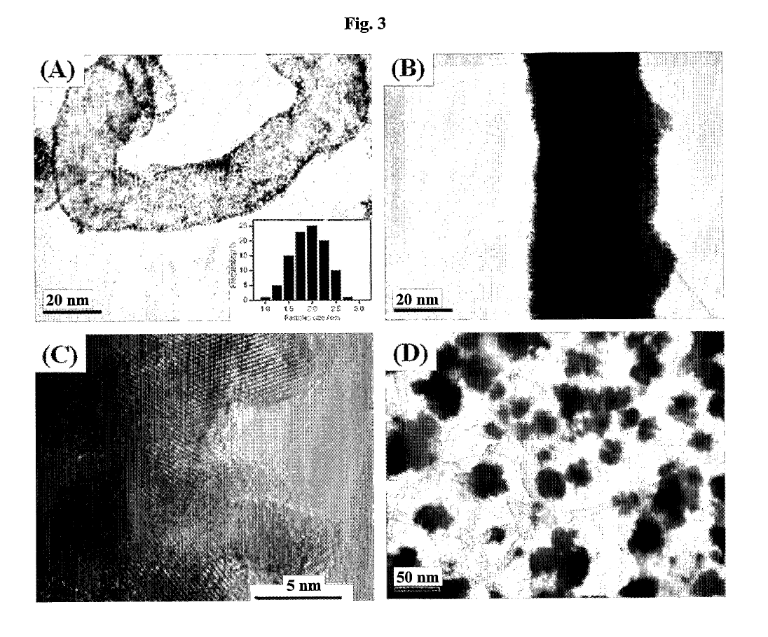

As illustrated in FIG. 2, use of stronger reducing agents, such as ascorbic acid would not lead to the formation of metal nanoparticles which are loaded on the nanostructured material but would result in the formation of metal nanoclusters as illustrated in FIG. 2 (see black stars in the left pathway) or FIG. 3(D). Stronger reducing agents, such as ascorbic acid result in a fast reduction and deposition of nanoclusters rather than nanoparticles. Therefore, when using stronger reducing agents such as ascorbic acid, stabilizers can be used. Thus, in one aspect, the suitable reducing agent is a combination or mixture of reducing agent and a stabilizer.

In other words, when using a reducing agent other than a reducing agent with a standard reduction potential (E⁰/V) other than between about 1 V to about 0.0 V, further stabilizers are added in case it is desired to avoid formation of metal particles at the surface of the polymer coated nanostructured material which are larger than between about 1 to 10 nm or 1 to 5 nm or 1 to 3 nm.

Examples for suitable stabilizers include, but are not limited to a surfactant, such as a cationic surfactant, e.g. cetyltrimethylammonium bromide (CTAB), an anionic surfactant, such as sodium dodecyl sulfate (SDS); a polymer, such as polyvinylpyrrolidone (PVP); and an ion salt, such as trisodium citrate. It is believed that such stabilizers function by the electrostatic stabilization or steric stabilization around metal nanoparticles to avoid the agglomeration of particles into nanoclusters. Such stabilizers are known in the art and are described for example by Mandal, M., Kundu, S., et al. (2003, Journal of Colloid and Interface Science, vol. 265, pp. 23) and Wang, W., Tian, X., et al. (2006, Colloids and Surfaces A: Physicochemical and Engineering Aspects, vol. 273, pp. 35).

Thus, in one aspect, the reducing agent is a reducing agent with a standard reduction potential (E⁰/V) between about 1 V to about 0.0 V or, in case the standard reduction potential lies outside the range of 1 V to about 0.0 V, a combination of a reducing agent and a stabilizer.

The reducing agent affects deposition and reduction of the noble metal precursor so that the formation (loading) of metal particles at the surface of the polymer coated or wrapped nanostructured material is affected. As shown in FIG. 1, the noble metal precursor reacts with the charged functional group of the polyelectrolyte bound to or coating the nanostructured material.

To induce reduction, the pH value is adjusted accordingly by addition of a basic solution, such as NaOH. The pH value is adjusted to be in a range between about 8 to 12. Reduction is carried out for a suitable amount of time. The reduction process is carried out at elevated temperatures, such as by refluxing the solution or heating it in a microwave. In general any kind of heating process can be applied as long as the solution is heated. Heating ensures that the metal precursors are completely reduced to metal nanoparticles.

Heating is carried out at a temperature which is suitable to bring the solution comprising the reactants to boil. The time for heating the solution should be long enough to ensure complete reduction of the metal precursors in the solution. Therefore, this time depends largely on the amount of metal precursor used and therefore has to be determined by a person skilled in the art carrying out the method of the present invention. In one example referred to herein heating was carried out for at least 3 hours. Further heating of the solution even after the reduction of the metal precursor is completed does not affect the product formed.

After completion of the reduction, the pH is adjusted to an acidic range, such as pH 2-5 or 3-4. Adjusting the pH to an acidic range allows deposition or “loading” of the nanoparticles on the nanostructured material.

The product of the deposition reaction is isolated by common methods known in the art, such as filtration, washing and drying.

The particle loading on the nanostructure material is also influenced by the amount of precursor material or metal oxide used. The amount of precursor material used depends on the desired metal nanoparticle loading for the nanostructured material. For example, when 30 mg of a nanostructured support material, such as CNT, is used, H₂PtCl₆ containing 7.5 mg, 12.8 mg, 20 mg, 30 mg and 45 mg of Pt are used for a nanoparticle loading of 20%, 30%, 40%, 50% and 60%, respectively. That means that for a nanoparticle loading rate of X % it is required to use an amount of the metal precursor, which includes an amount of metal atoms, which weight is about X % of the combined weight of the nanostructured material used and metal atoms required. Thus, a person skilled in the art can readily determine the nanoparticle loading on the nanostructured material and can vary it depending on the desired application. With the method of the present invention high loading rates of more than 80 or 90% can be achieved.

The above method results in a nanostructured material loaded with metal particles which show a very narrow size distribution. In general, the size of the particles formed is between about 1 to 10 nm or 1 to 3 nm, i.e. nanoparticles are formed. In other words the size of the metal particles loaded is about 10 nm±1 nm or 2 nm±1 nm.

In one example, at a metal particle loading of 20 wt. % based on the total amount of nanostructured material, the average particle size is between about 1.25 to about 2.25 nm. In another example, at a metal particle loading of 40 wt. % based on the total amount of nanostructured material, the average particle size is between about 1.5 to about 2.5 nm. At a metal particle loading of 60 wt. % based on the total amount of nanostructured material, the average particle size is between about 1.75 to about 2.75 nm. Higher loading and smaller particle size can for example increase the catalytic activity in cases where catalytic particles are loaded onto the surface of the polymer coated nanostructured material.

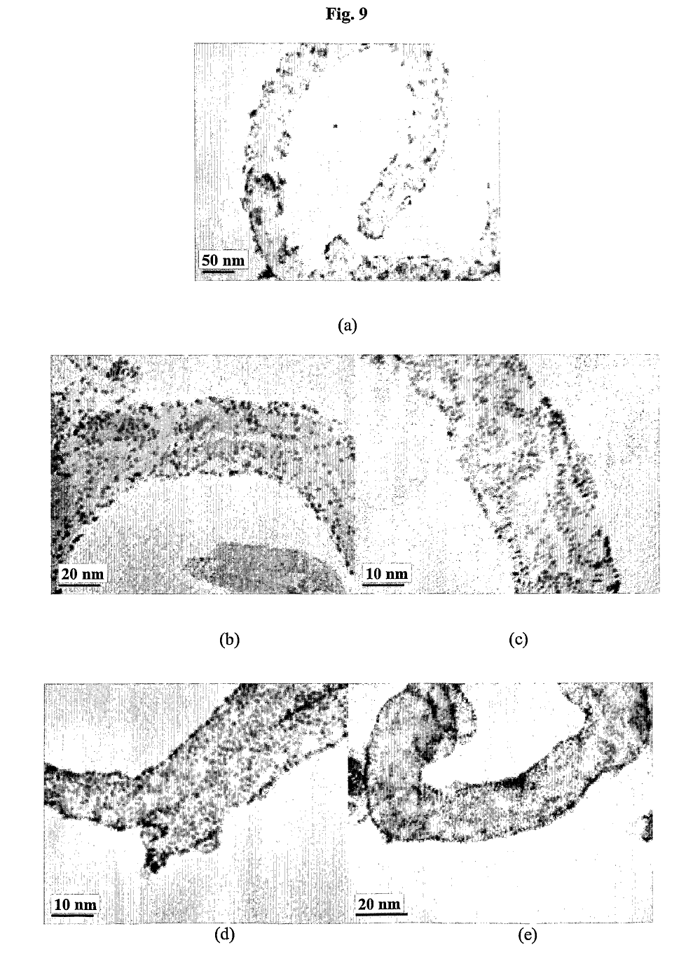

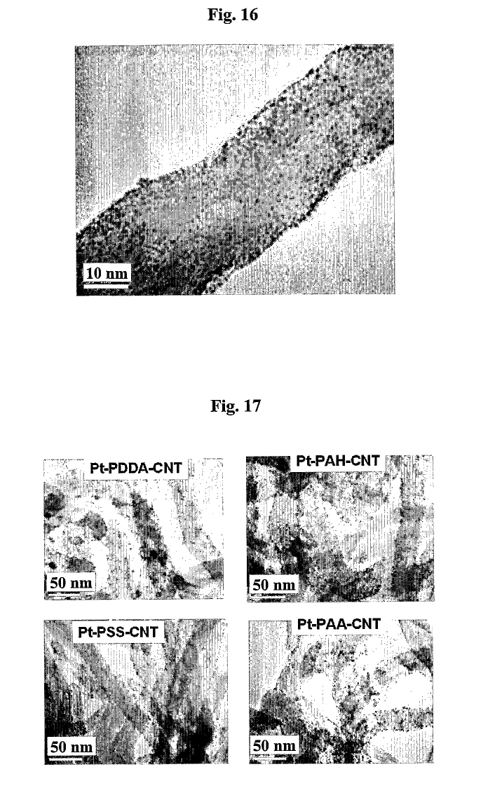

The inventors also found that the size of the metal nanoparticles can be further reduced by up to 20% compared to normal heating methods by subjecting the dispersion of polymer coated nanostructured material and noble metal precursor to microwaves, i.e. electromagnetic waves with wavelengths ranging from 1 mm to 1 m (frequencies between 0.3 GHz and 300 GHz). The microwave heating can be carried out in the presence of polyols, i.e. alcohols containing multiple hydroxyl groups. Subjecting the dispersion to microwaves can be carried out for a period of between about 1 to 3 min. For example, FIG. 16 describes the results of an experiment using carbon nanotubes (CNT) and a Pt metal precursor in which the size of the Pt nanoparticles has been reduced to an average size of about 1.6 nm when heating the reaction solution comprising the polyelectrolyte coated nanostructured material and the Pt metal precursor for about 1 min in a microwave. For example, conducting the same experiment but using refluxing to heat the solution instead of a microwave treatment leads to an average size of the Pt nanoparticles of about 2 nm (see FIG. 9b). It is believed that subjecting the solution to microwaves can accelerate the reaction rate, which again leads to a smaller metal particle size. In addition, using microwave (1 to 3 min) heating instead of reflux (up to 3 h) can reduce the reaction time and thus the costs for this process considerably.

After isolating the nanoparticle loaded nanostructured material it is possible to subject them to a further process resulting in the formation of a metal layer on the nanoparticle loaded nanostructured material. Therefore, in another aspect, the present invention refers to the manufacture of a nanoparticle coated nanostructured material comprising a layer of a noble metal or metal oxide which is located on top of the nanoparticle coated nanostructured material. This method comprises:
dispersing and heating the metal particle loaded nanostructured material in a solution;
adding a reducing agent and continuing heating;
adding a solution comprising a second noble metal precursor or metal oxide to the heated dispersion, wherein said second noble metal precursor or metal oxide is added sequentially; and
heating the dispersion for a time suitable to form a metal film on the surface of the metal particle loaded nanostructured material.

The solvent or solution in which the metal particle coated nanostructured material is dispersed can be, for example, an aqueous solution or any other solvent suitable for the respective reducing agent used. Such solvents or solutions are generally known in the art. Heating is normally carried out at a temperature between about 80 to 100° C. In another example, heating means that the solution in which the metal particle coated nanostructured material is dispersed (dispersion), is brought to boil, i.e. the dispersion is heated up to the boiling point of the solvent. The time for heating the dispersion is between about 10 min to 50 min or 20 min to 40 min or 20 min to 30 min. In one example, the dispersion was heated for about 20 or 30 min.

The reducing agent added can be one of the reducing agents mentioned above. After addition of the reducing agent, the dispersion now including the metal particle loaded nanostructured material and the reducing agent, is continuously heated or boiled. This heating step of the solution allows that the reduction of the second metal precursor can occur immediately once the second metal precursor is added. The time for heating of this solution is of less importance as the time for heating does not influence the formation of the product formed therein.

Subsequently, a second noble metal precursor or metal oxide is added sequentially to the dispersion comprising the metal particle loaded nanostructured material and the reducing agent. The second noble metal precursor comprises a noble metal as mentioned above for the manufacture of the metal particle loaded nanostructured material. Also, the second noble metal precursor or the metal oxide can include one of the noble metal precursors as mentioned above for the manufacture of the metal particle loaded nanostructured material. The noble metal of the second noble metal precursor or the second noble metal precursor can be the same or different as the noble metal of the noble metal precursor referred to above or the second noble metal precursor referred to above for the manufacture of the metal particle loaded nanostructured material.

Examples for a metal oxide include, but are not limited to Ag—MnO₂, Al₂O₃, MoO₃, MnO₂, V₂O₅, TiO₂, SiO₂, ZnO₂, SnO₂, Fe₂O₃, NiO, Co₃O₄, CoO, Nb₂O₅, W₂O₃, and mixtures thereof. The metal oxide can be either stoichiometric or non-stoichiometric (e.g. Meₙ₋ₓO_{m-y}, 0<x<1;0<y<1; 1≦n≦3; 1≦m≦5).

“Sequentially” means that the second noble metal precursor or metal oxide has not been added in one batch but continuously to ensure that the amount of reducing agent always exceeds the amount of unreduced second noble metal precursor or metal oxide in the dispersion. Sequential or continuous addition of the second noble metal precursor or metal oxide can be achieved, for example, by adding the solution continuously drop by drop (dropwise). Continuous and slow addition of second noble metal precursor or metal oxide ensures that the exceeding amount of reducing agent drives the reduction of the metal to completion which again results in the formation of a contiguous metal layer on top of the nanostructured material loaded with metal (nano)particles. The thin contiguous metal film or layer is formed by metal particle aggregates which form based on the metal nanoparticles already loaded on the nanostructured material. The inventors found that seeding, i.e. providing a nanostructured material loaded with metal nanoparticles is a necessary requirement to obtain a nanostructured material with a contiguous layer made of a noble metal or metal oxide.

During the addition of the second noble metal precursor or metal oxide, the ratio of reducing agent to second noble metal precursor or metal oxide is between about 1:1 to 10:1. For example, the ratio can be about 3:1 to 6:1 or 4:1 to 5:1. In one example, the ratio is about 5:1.

The thickness of the metal layer or film formed on the nanostructured material loaded with (nano)particles can be adapted by varying the volume or total amount of second noble metal precursor or noble metal oxide added to the reaction mixture (dispersion). In general, the percentage of second noble metal precursor or metal oxide can be about 50% to 90% wt. % based on the total weight of the nanoparticle loaded nanostructured material. In one example, the metal layer is a single film of a noble metal or a metal oxide.

In case the nanostructured material is consisting of nanotubes, as used in one of the examples given below, the metal layer forms a sheath around the nanostructured material. In general, the thickness of the metal layer or the sheaths depends on the amount of second noble metal precursor or metal oxide used but is in general in the nanometer range. The minimal thickness can be about 4 nm, and the maximum thickness can be about 20 nm.

In another aspect, the present invention refers to a nanostructured material loaded with metal (nano)particles or to a nanostructured material coated with a metal film obtained by any of the methods described above.

In another aspect the present invention refers to nanostructured material loaded with metal particles, wherein this material comprises:
a polyelectrolyte which is bound to the nanostructured material;
noble metal particles which are bound to the polyelectrolyte;
wherein the particles have a size of between about 1 to 10 nm or 1 to 5 nm or 1 to 3 nm.

Also, the particle loading on the nanostructured material is 50 wt. % based on the total amount of the nanostructured material loaded with metal particles.

The polyelectrolyte is forming a layer which is covering the nanostructured material and thus serves as primer for the homogenous deposition of metal particles. The metal particles start forming at the positively or negatively charged groups provided by the polyelectrolyte surrounding or covering the nanostructured material.

The size of the particles formed is between about 1 to 10 nm or 1 to 5 nm or 1 to 3 nm. In other words the size of the metal particles is about 2 nm±1 or even±0.75 nm or ±0.5 nm. The particle loading can be as high as 50, 60, 70, 80, 85 or 90 wt. % based on the total amount of the nanostructured material. The metal particles are dispersed on the nanostructured material without forming particle aggregates which increases its total surface area and, for example, can thus increase its catalytic activity in certain applications.

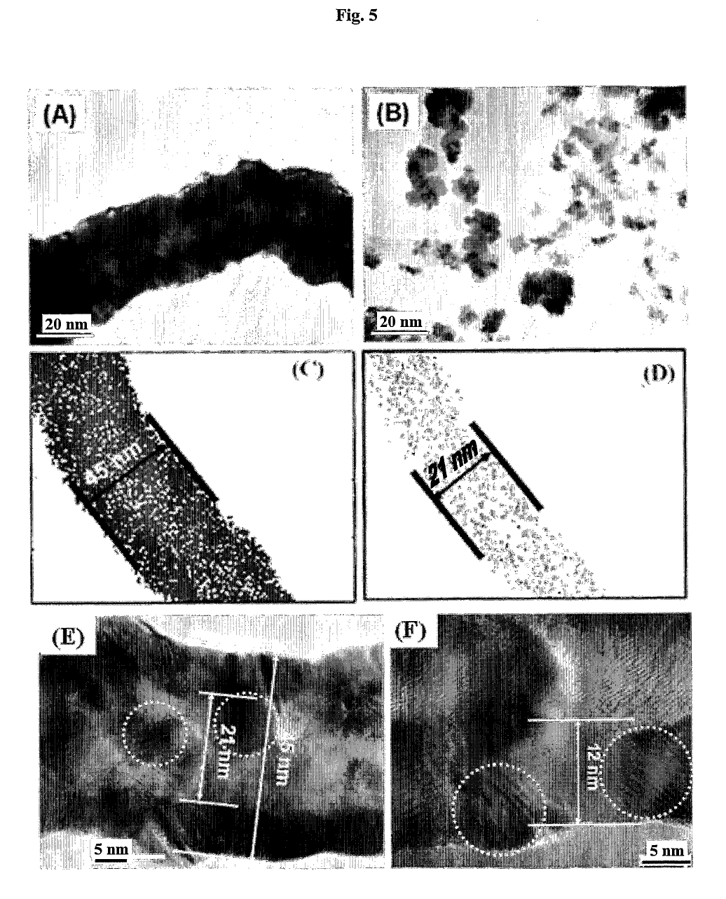

In another aspect, the present invention refers to a metal coated nanostructured material. In other words, the present invention refers also to a nanostructured material covered or coated with a layer of a noble metal or a metal oxide. This material comprises a nanostructured material loaded with noble metal particles of the present invention and a film or layer comprised of a second noble metal or a metal oxide which is formed on top of the nanostructured material loaded with metal particles. This film or layer is contiguous layer or film covering the nanostructured material loaded with metal particles. This layer has a thickness of between about 4 nm to about 20 nm. Examples of such metal coated nanostructured material are shown in FIG. 5.

In one example, a nanostructured material loaded with platinum nanoparticles has been coated with a layer of palladium. The thin contiguous film or layer is formed by metal particle aggregates which form based on the metal nanoparticles already loaded on the nanostructured material coated with the polyelectrolyte.

In another aspect, the present invention refers to an electrode, for example an electrode which can be used in a fuel cell or a metal-hydride battery, comprising a nanostructured material loaded with (nano)metal particles or a metal coated nanostructured material of the present invention. The present invention also encompasses a method of manufacturing such an electrode. In still another aspect, the present invention refers to the use of a nanostructured material loaded with (nano)metal particles or a metal coated nanostructured material of the present invention for an electrode, such as an electrode for a fuel cell or a metal-hydride battery, or for the manufacture of such an electrode. In still another aspect, the present invention refers to a method of manufacturing an electrode comprising forming the nanostructured material obtained by a method of the present invention or a nanostructured material of the present invention into a membrane. This membrane can be used for the manufacture of an electrode.

As to some more specific examples of possible uses of the present invention, Pd nanoparticles supported on carbon and carbon nanotubes are widely used as effective electrocatalysts for alcohol oxidation in acid and alkaline media for direct alcohol fuel cells (DAFCs). PtRu alloy electrocatalysts are the most common catalysts for the electrooxidation of methanol, ethanol and other alcohols for direct alcohol fuel cells. The manufacture of nanostructured material loaded with PtRu alloy is described further below.

Direct methanol and direct alcohol fuel cells (DMFCs and DAFCs) can be used for portable electronics devices, such as, personal digital assistants (PDAs), cell phones, notebook personal computers, etc. The advantage of a DMFC is that it operates at room temperature, uses liquid methanol as the fuel, and eliminates the expensive setup of hydrogen reformers and the hydrogen storage problem. However, the development of DMFCs and DAFCs technologies is seriously hampered by two main challenging problems: (i) the low electrooxidation activity of Pt-based electrocatalysts for methanol, ethanol, isoproponal, and formic acid; and (ii) the significant methanol crossover from the anode to the cathode through the polymer membrane. In the case of DAFCs based on other alcohol fuels, the crossover problem is not as serious as methanol. Pd and Pd-based nanoparticles are shown to be effective electrocatalysts for the electrooxidation of ethanol, proponal and formic acid under certain conditions.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non- limiting examples. In addition, where features or aspects of the invention are described in terms of Markush groups, those skilled in the art will recognize that the invention is also thereby described in terms of any individual member or subgroup of members of the Markush group.

### Experimental Section

The following components which are used in the following examples, were obtained from the following sources: Milli-Q water (resistivity >18.0 MΩcm), Poly(diallyldimethylammonium chloride) (PDDA, 20 wt % in water, MW=5,000-40,000, Aldrich), H₂SO₄ (99.5%, Fluka), methanol (Fluka), multi-walled carbon nanotubes (Shenzhen nano, port), hexachloroplatinic(IV) acid (H₂PtCl₆) (Sigma-Aldrich), ethylene glycol (Fluka), sodium hydroxide (Fluka), sodium chloride (Fluka), HCl (Sigma-Aldrich), PdCl₂ (Sigma-Aldrich), ruthenium chloride (RuCl₃) (Sigma-Aldrich), nitric acid (65%, Fluka), ethanol (Fluka), 1-aminopyrene (1-AP, Sigma-Aldrich), Nafion® solution (5% in isoproponal and water), and carbon black (XC-72, Gashub). All the chemicals and powders were used as received without further purification.

1. Synthesis of PDDA-Wrapped Carbon Nanotubes

Multi-walled carbon nanotubes (MWCNTs) have been used exemplarily as nanostructured material. MWCNTs (100 mg) (SYST Integration PTE LTD) were first ultrasonically suspended in deionized water (400 ml) in the presence of PDDA (5 wt. %) and NaCl (1 wt. %) to yield a stable nanotube suspension. The positively charged ammonium groups of PDDA serve as primers for the homogeneous deposition of platinum. Addition of NaCl can affect the polymeric chain configuration in the polyelectrolyte solution. If no salt is added, similar charges within a PDDA chain can repel each other, resulting in a rod-like configuration of the chain. However, any configuration of the PDDA chain is suitable to be used in the present invention but the addition of salts prefer configuration which can yield a more homogeneous distribution of the polyelectrolyte and thus subsequently a higher metal particle loading.

The suspension was filtrated, washed several times to remove excess PDDA and NaCl, then vacuum dried (70° C./24 hr).

For the purpose of comparison, acid oxidized MWCNTs were prepared by refluxing MWCNTs in a mixed acid (H₂SO₄:HNO₃ in 1:1 v/v ratio) solution at 140° C. for 4 h. Similarly, the solution was filtrated using nylon membranes and dried in vacuum oven at 70° C. for 24 hrs. The acid oxidation treated MWCNTs is termed AO-MWCNTs.

2. Manufacture of PDDA Wrapped Nanotubes Loaded with Pt Nanoparticles (Pt-PDDA-MWCNTs)

For in situ deposition of Pt metal particles, the PDDA coated tubes (30 mg) were mixed ultrasonically with H₂PtCl₆ (sufficient for a Pt loading of 50 wt %) in ethylene glycol (EG) after which the pH was adjusted to 12.5 by adding NaOH (2.5 M) dropwise.

Afterwards, reduction of platinum was driven by refluxing the solution at 130° C. for 3 h. After the reduction, the pH was adjusted back to 3-4.

In the case of deposition of Pt nanoparticles on acid oxidized MWCNTs (AO-MWCNTs), the procedure is similar. After the deposition of nanoparticles, MWCNTs supported Pt catalysts were obtained by filtrating the resultant solution and washing for several times using nylon filter membrane followed by the drying in vacuum oven at 70° C. for 24 hours.

3. Characterization of Pt-PDDA-MWCNTs and Electrochemical Measurement

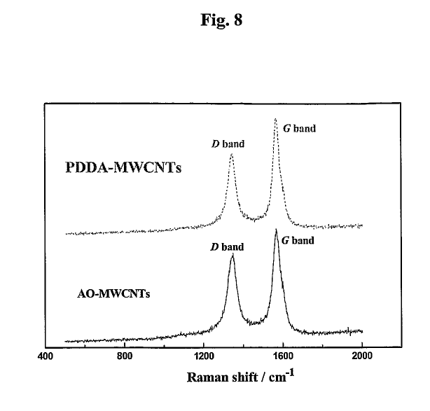

Raman characterization—The Raman spectroscopy has been used to study the surface structure of unoxidized PDDA-wrapped MWCNTs and acid oxidized MWCNTs. As shown in FIG. 8, both MWCNTs have similar Raman scattering patterns. The peak near 1344 cm⁻¹ is assigned to the disordered graphite structure (D-band), and the high frequency peak at near 1567 cm⁻¹ (G-band) corresponds to a splitting of the E_{2g} stretching mode of graphite, which reflects the structural intensity of the sp²-hybridized carbon atoms. Thus the extent of the modification or defects in MWCNTs can be evaluated by the intensity ratio of the D- and G-bands. The intensity ratios of I_{D}/I_{G} are 0.71 and 0.81 for PDDA wrapped MWCNTs and acid-oxidized MWCNTs, respectively. This result indicates that acid oxidation method caused more structural damage on MWCNTs which would potentially decrease the electrical conductivity of MWCNTs and lower the corrosion resistance. In contrast, PDDA wrapping method doe not cause any structural damage and in the same time provides sufficient and uniform functional groups on the surface of MWCNTs.

TEM characterization—Size distribution and morphology of Pt nanoparticles deposited on unoxidized PDDA-wrapped MWCNTs and acid oxidized MWCNTs (AO-MWCNTs) are examined by Transmission electron microscopy (TEM). FIG. 9(a) shows the TEM images of 20 wt % Pt-AO-MWCNTs, where a poor dispersion of Pt nanoparticles on MWCNTs and a large number of aggregates were found. In the case of AO-MWCNTs, the defects generated by the acid oxidation are usually not uniform. When Pt nanoparticles are deposited on the MWCNTs, the particles tend to deposit on these localized defect sites. This explains the poor dispersion and extensive aggregation.

In contrast, in FIG. 9(b)-(e), Pt nanoparticles of smaller size (average size 2 nm vs 5 nm for Pt-AO-MWCNTs) were evenly deposited on the PDDA-MWCNTs. Even when the Pt loading is increased to 40%, a very uniform dispersion can still be obtained on the PDDA-MWCNTs and no or little agglomeration was observed. This shows that PDDA wrapped MWCNTs are much more effective supports than acid oxidized MWCNTs. In the case of AO-MWCNTs, the harsh acid oxidation condition also leads to the structural damage of MWCNTs, which would cause the loss in the electrical conductivity and thus potentially reduces the electro-catalytic activity of the catalyst.

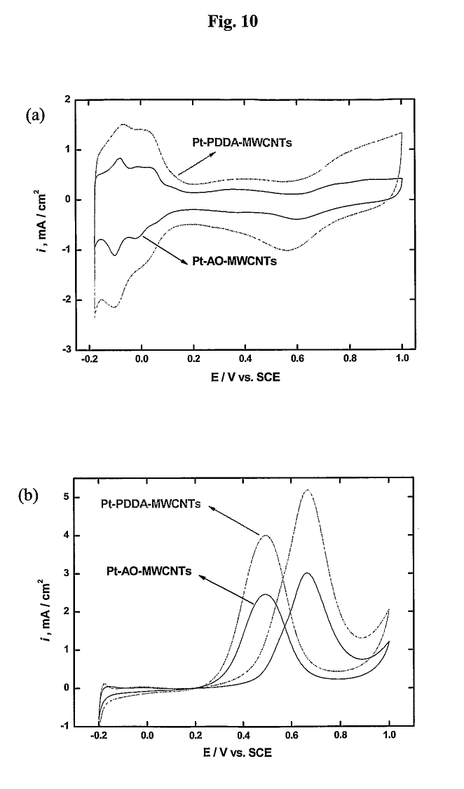

Electrochemical measurement—Cyclic Voltammograms (CVs) of Pt loaded MWCNTs were measured in nitrogen purged 0.5 M H₂SO₄ solutions, as shown in FIG. 10(a). The Pt electrochemically active surface area can be obtained from the area of hydrogen desorption peak after correcting for the double layer charging current. It can be seen that Pt-PDDA-MWCNTs exhibit higher electrochemically active surface area than Pt-AO-MWCNTs, apparently due to smaller Pt size and better dispersion of the Pt-PDDA-MWCNTs, as supported by TEM and XRD results. This also demonstrates that the Pt deposited on PDDA wrapped MWCNTs are electrochemically accessible, which is very important for fuel cell reactions. Using methanol electro-oxidation reaction as an example, the catalytic properties of Pt-PDDA-MWCNTs and Pt-AO-MWCNTs were characterized by CV in a nitrogen purged 0.5 M H₂SO₄+1.0 M CH₃OH solutions. As shown in FIG. 10(b), the Faradaic current exhibits the well-known features of methanol oxidation on Pt based catalyst. As a kinetically controlled reaction, the activity of methanol oxidation on Pt can be represented by the magnitude of the anodic peak. The higher anodic current indicates a higher electro-catalytic activity on Pt-PDDA-MWCNTs, in agreement with the observation of higher electrochemically active surface area.

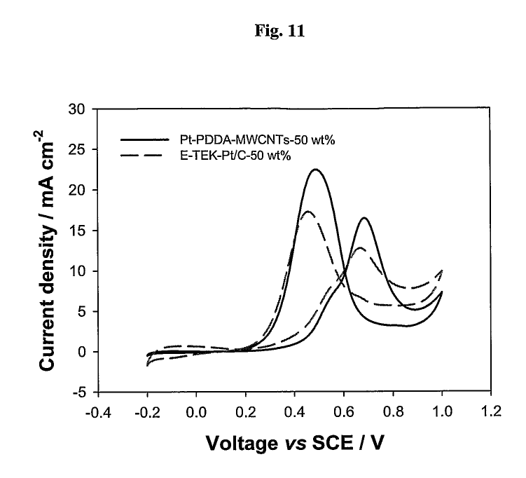

FIG. 11 shows the cyclic voltammetry curves of Pt catalysts supported on PDDA-MWNTs and commercial E-TEK Pt/C electrocatalysts on 0.5 M H₂SO₄+1.0 M CH₃OH under the same Pt loading of 0.02 mg/cm² at room temperature. The results show that Pt-PDDA-MWCNTs electrocatalysts synthesized in the present invention show much higher electro catalytic activity than that of commercial E-TEK Pt/C electrocatalysts.

4. Synthesis of Pd-PDDA-MWCNTs

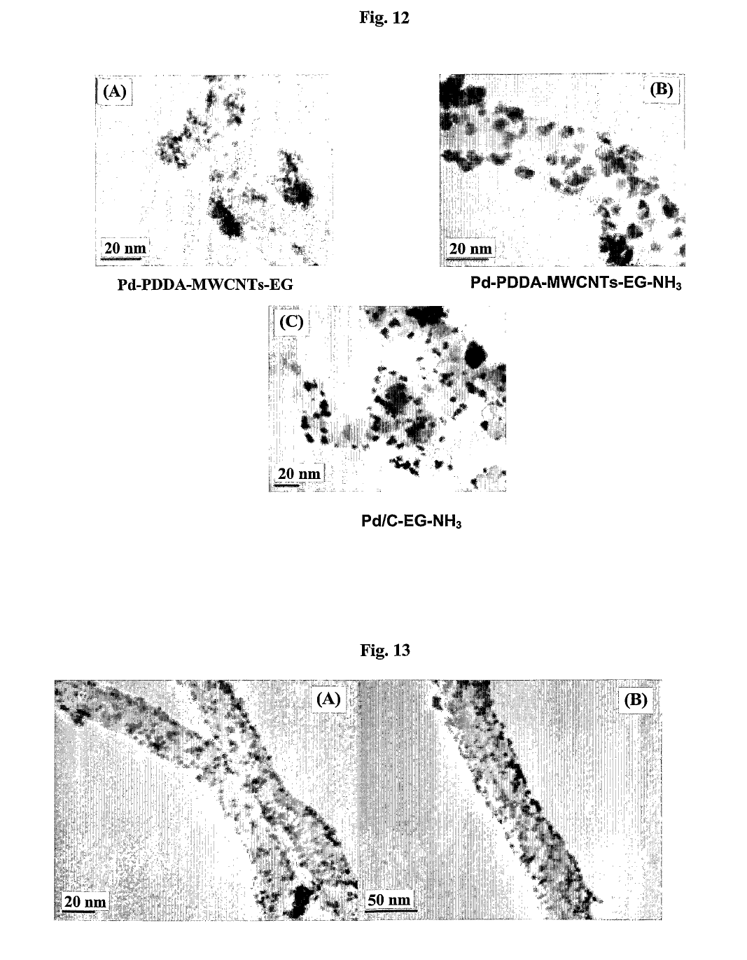

Pd-PDDA-MWCNTs electrocatalysts were synthesized as follows: adding 1 ml 1.0 M HCl aqueous solution into PdCl₂—ethylene glycol solution, stirring for 30 mins, and then adding PDDA-MWCNTs into the solution under sonication. After the formation of a good dispersion solution, ammonium hydroxide was added. Finally, adjust pH to 12.5 followed by reflux for 3 h at 130° C. FIG. 12 shows the TEM micrographs of Pd-PDDA-MWCNTs. Mediation by NH₃ significantly improves the dispersion and distribution of Pd nanoparticles.

Thus, in one aspect of the invention, the dispersion of reacted nanostructured material, noble metal precursor or metal oxide, and reducing agent can require the addition of further substances, like a basic substance, such as NH₃, to further improve dispersion and distribution of the metal particles formed. However, in case of Pd-PDDA-MWCNTs, even without the addition of NH₃, the distribution and dispersion of metal particles already improved compared to the metal coated MWCNTs known in the art.

Distribution of Pd nanoparticles on MWCNTs can be significantly improved by using microwave heating during the deposition of Pd nanoparticles on PDDA-functionalized MWCNTs. In this process, PDDA-wrapped MWCNTs were mixed with K₂PdCl₄ under sonication for 30 mins followed by the adjustment of pH to 12. The as-prepared suspension was placed in a conventional microwave oven for 1 mins. After the suspension was cooled down to room temperature, 1.0 M HCl aqueous solution was added to adjust pH to 3-4 and stirred for 1 h followed by the filtration. FIG. 13 shows the TEM micrographs of Pd-PDDA-MWCNTs prepared by microwave assisted EG method.

5. Synthesis of PtRu-PDDA-MWCNTs

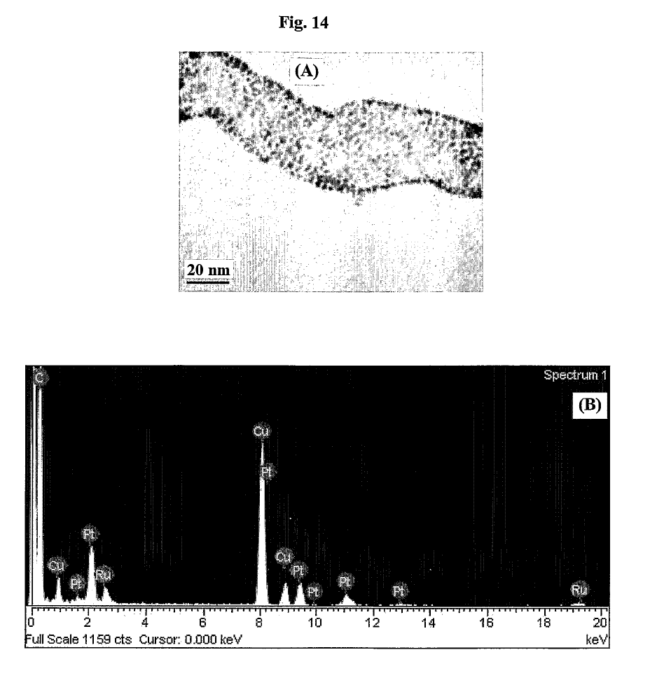

The synthesis procedure of PtRu-PDDA-MWCNTs nanoparticles is as follows: 3.75 ml of 10 mM H₂PtCl₆ and 3.75 mL of 10 mM RuCl₃ were mixed well with 30 mg of PDDA wrapped MWCNTs in 50 ml of EG solution. After 1 hour sonication, the pH value of the reaction system was adjusted to 12.5 followed by refluxing at 130° C. for 3 hours. The obtained solution was added 2 ml HCl of 1 M to adjust pH to 3-4, followed by the filtration and dry in vacuum oven. FIG. 14 shows the TEM images and corresponding energy dispersive detector (EDS) spectrum of PtRu-PDDA-MWCNTs nanoparticles. FIG. 14 confirms the uniform dispersion of as-prepared PtRu nanoparticles on CNT, the particle size is about 2.5 nm. FIG. 14B, the EDS result confirms the existence of Pt and Ru.

TABLE 1
Element Analysis by EDS of PtRu-PDDA-MWCNTs

| Element | Weight % | Atomic % |
|---|---|---|
| C | 26.78 | 69.07 |
| Cu | 56.86 | 27.72 |
| Ru | 4.18 | 1.28 |
| Pt | 12.18 | 1.93 |
| Total | 100.00 | 100.00 |

The element distribution of PtRu-PDDA-MWCNTs as determined with an energy dispersive detector (EDS) is given in Table 1. The results show that Pt to Ru atomic ratio is close to 1:1, indicating the successful co-deposition of PtRu alloy nanoparticles. PtRu alloy electrocatalysts are the most common catalysts for the electrooxidation of methanol, ethanol and other alcohols for direct alcohol fuel cells. Similar to PtRu-PDDR MWCNTs, 1-aminopyrene (1-AP) can also be used to coat the CNTs, i.e. to coat the CNTs, forming PtRu-1-AP-MWCNTs.

5.5 Synthesis of PtRu-1-AP-MWCNTs

1-AP- and Acid-Functionalization of MWCNTs

The procedure for the noncovalent functionalization of MWCNTs using 1-AP is as follows. First, 200 mg of pristine MWCNTs was sonicated in 100 mL of ethanol containing 20 mg of 1-AP for 1 h and stored at room temperature overnight. Then the above solution was filtered using a nylon filter membrane and washed, and the filtration was repeated several times. The as-functionalized MWCNTs were dried in a vacuum oven at 70° C. for 10 h and collected (denoted as 1-APMWCNTs). As a comparison, MWCNTs were also functionalized by a conventional acid treatment. In this treatment, 200 mg of MWCNTs was treated in 200 mL of a mixed strong acid solution (H₂SO₄:HNO₃ in 1:1 v/v ratio), followed by refluxing at 140° C. for 4 h. The obtained solution was then diluted with 2 1 of DI water to reduce the acidity of the solution, followed by filtration. The acid-treated MWCNTs were washed for several times and dried in a vacuum oven at 70° C. for 24 h. The acid-treated MWCNTs are denoted as AO-MWCNTs.

Synthesis of PtRu/MWCNTs Electrocatalysts.

To deposit the PtRu nanoparticles on 1-AP-functionalized MWCNTs, 30 mg of 1-AP-MWCNTs was mixed with approximate amount of H₂PtCl₆ and RuCl₃ with a molar ratio of Pt/Ru) 1:1 in ethylene glycol (EG) solution under ultrasonication in a beaker. The solution was controlled at a pH of slightly less than 7 (e.g., pH 6.5) to maintain a weak acidity. The beaker was then placed in a microwave oven and heated for 2 min. The solution changed from light yellow to dark brown, indicating the reduction and formation of PtRu nanoparticles on MWCNTs. The solution was then filtered using a nylon filter membrane and washed, and the filtration was repeated several times. The obtained PtRu electrocatalysts on 1-AP-functionalized MWCNTs (PtRu/1-AP-MWCNTs) were dried in a vacuum oven at 70° C. for 24 h. PtRu electrocatalysts on acid-functionalized MWCNTs (PtRu/AO-MWCNTs) and XC-72 carbon black (PtRu/C) were prepared using similar procedures as described above. PtRu nanoparticles with different total metal loading (20 and 40 wt %) were obtained on 1-AP-MWCNTs and AO-MWCNTs through controlling the concentration of H₂PtCl₆ and RuCl₃.

Characterization

UV-visible spectroscopy was used to confirm the existence of 1-AP after 1-AP functionalization of MWCNTs. The samples were dissolved in tetrahydrofuran (THF) prior to the UV-visible spectroscopy measurement. The effect of 1-AP and acid functionalization methods on the surface structure of MWCNTs was also examined by Raman spectroscopy (Renishaw), using He/Ne laser with a wavelength of 633 nm. The transmission electron microscopy (TEM, JEOL 2010) was performed on PtRu/MWCNTs and PtRu/C electrocatalysts using the acceleration voltage of 160 kV. An X-ray diffractometer, D/Max-IIIA (Rigaku Co.), using Cu KR1 (λ=1.540 56 Å) as the radiation source was used for identification of the crystalline structure and average crystallite size of Pt particles. The tube current and voltage were 25 mA and 35 kV, respectively. The average crystallite size of Pt particles was estimated from the diffraction peak of Pt(220) using the Debye-Scherrer equation:

d=0.9λ_{Kα1}/β cos θₘₐₓ

in which d is the average size of the Pt particle, λ_{Kα1} the X-ray wavelength (Cu Kαλ_{Kα1}=1.5418 Å), θₘₐₓ. an is the maximum angle of the (220) peak, and β is the full-width at half-maximum in radians.

Electrochemical Measurement

The electrochemical activity of PtRu/1-AP-MWCNTs-20 wt. %, PtRu/AO-MWCNTs-20.wt %, and PtRu/C-20.wt. % electrocatalysts was measured for the electrooxidation of methanol. Generally, ˜4 mg of electrocatalyst sample was ultrasonically mixed in 4 mL of ethanol to form a homogeneous ink followed by dropping 20 μL of the electrocatalyst ink onto the surface of a glass carbon electrode (GCE). The diameter of GCE was 4 mm. Then, 1 μL of Nafion solution of 0.5% in 2-propanol was added to fix the electrocatalysts on the GCE surface. Pt wire and Ag/AgCl electrode were used as the counter and reference electrodes, respectively. All potentials in the present study were given versus Ag/AgCl reference electrode. The electrochemical active area of PtRu/MWCNTs and PtRu/C electrocatalysts was measured in a nitrogen-saturated 0.5 M H₂SO₄ solution at a scan rate of 50 mV/s and the elelctrocatalytic activity for the methanol oxidation reaction was measured in a nitrogen-saturated 0.5 H₂SO₄+1.0 M CH₃OH solution at a scan rate of 50 mV/s. For the electrochemical tests for PtRu/1-AP-MWCNTs-40.wt % and PtRu/AO-MWCNTs-40.wt %, 10 μl of the as-prepared electrocatalyst ink using the above procedure was placed on the GCE. The Pt metal loading was kept at 2.68 μg. The tests were conducted at room temperature.

The noncovalent functionalization involves a bifunctional molecule, 1-AP, irreversibly adsorbed onto the inherently hydrophobic surfaces of MWCNTs. 1-AP is a bifunctional molecule with a pyrenyl group and an amino functional group. The pyrenyl group, being highly aromatic in nature, interacts strongly with the basal plane of graphite via π-stacking. In similar manner, the pyrenyl group of 1-AP could also strongly interact with the sidewalls of MWCNTs, immobilizing the 1-AP on the MWCNTs. When the pH of the solution is controlled at slight acidity (e.g., pH 6.5), the amino groups of 1-AP immobilized on the MWCNTs surface become weakly positively charged. This leads to the self-assembly of the negatively charged Pt precursors, PtCl₆²⁻, followed by the subsequent self-assembly of positively charged Ru precursors, Ru³⁺, on the 1-AP-functionalized MWCNTs, forming an uniformly distributed PtRu precursors on the surface of MWCNTs. The microwave-assisted polyol treatment in the presence of ethylene glycol reduces the PtRu precursors, forming PtRu nanoparticles on the MWCNT surface.

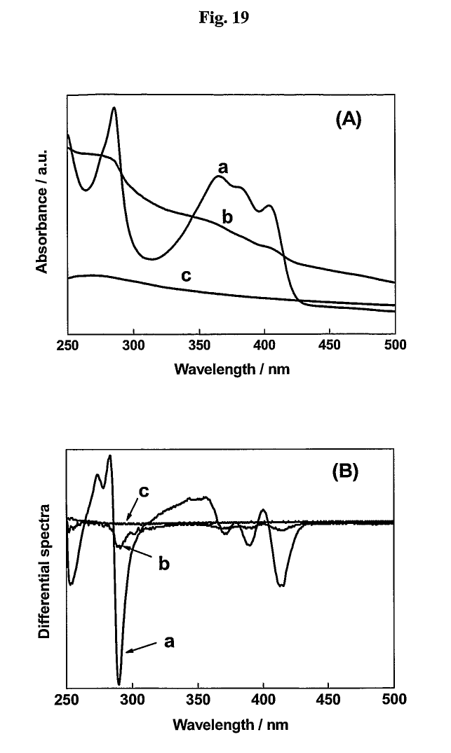

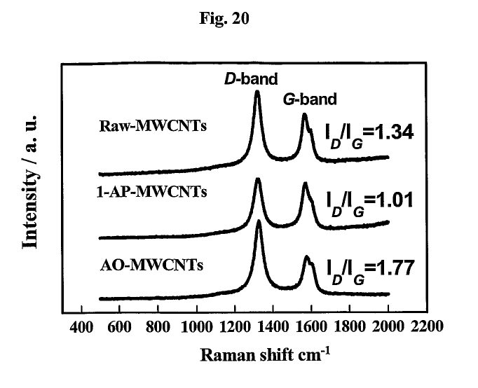

FIG. 19 is the UV-visible spectroscopy curves of 1-AP, 1-AP functionalized MWCNTs, and pristine MWCNTs. The results confirm the successful noncovalent binding between 1-AP and MWCNTs. The raw or pristine MWCNTs show a typical featureless spectrum (curve c in FIG. 19). 1-AP-functionalized MWCNTs show additional peaks around 355 and 290 nm (curve b in FIG. 19). This corresponds to the characteristic peaks of 1-AP at around ca. 285 and 365 nm (curve a in FIG. 19). The appearance of the additional peaks in the differential UV-vis curves (FIG. 19b) indicates the successful functionalization of MWCNTs by 1-AP via the π-π interaction between the pyrenyl groups of 1-AP and the six-membered rings of the sidewalls of MWCNTs. This is similar to the immobilization of 1-pyrenebutanoic acid succinimidyl ester on the sidewalls of single-walled carbon nanotubes via π-stacking.

The Raman spectroscopy was used to study the surface structure of 1-AP-MWCNTs, AO-MWCNTs, and pristine MWCNTs, and the results are shown in FIG. 20. MWCNTs with and without functionalization treatment have similar Raman scattering patterns. The peak near 1328 cm⁻¹ is assigned to the disordered graphite structure (D-band), and the high frequency peak at near 1577 cm⁻¹ (G-band) corresponds to a splitting of the E_{2g} stretching mode of graphite, which reflects the structural intensity of the sp²-hybridized carbon atoms. Thus, the extent of the modification or defects in MWCNTs can be evaluated by the intensity ratio of the D- and G-bands. The intensity ratios of I_{D}/I_{G} are 1.34, 1.01, and 1.77 for pristine-MWCNTs, 1-AP-functionalized MWCNTs, and acid-oxidized MWCNTs, respectively. The slightly decreased I_{D}/I_{G} ratio for 1-AP-functionalized MWCNTs as compared to that of pristine MWCNTs indicates that immobilization or wrapping of 1-AP or any other polyelectrolyte mentioned herein on the sidewalls of MWCNTs via π-stacking has no detrimental effect on the surface structure of carbon nanotubes. Rather, the decreased ratio suggests the coverage of the original defect sites by the 1-AP molecules. On the other hand, the intensity of the I_{D}/I_{G} ratio of AO-MWCNTs is 1.77, much higher than 1.34 of the pristine MWCNTs. This indicates that the harsh chemical acid treatment produces carboxylic acid sites on the surface, causing significant structural damage of MWCNTs. This would decrease the electrical conductivity of MWCNTs and lower the corrosion resistance. In contrast, the 1-AP functionalization method (i.e. coating or wrapping of nanostructured material) preserves the integrity and electronic structure of carbon nantotubes and provides highly effective functional groups on the surface of MWCNTs for the subsequent deposition of PtRu nanoparticles.

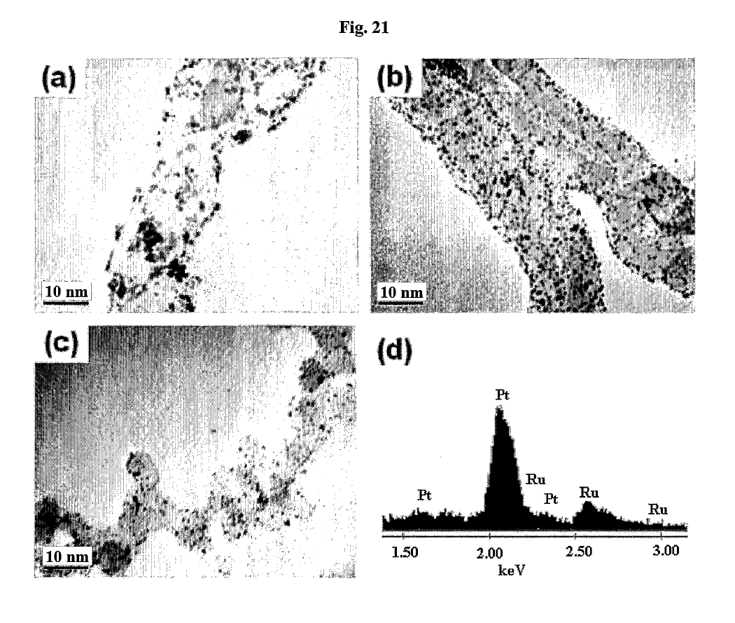

FIG. 21 shows the TEM micrographs of the PtRu nanoparticles deposited on AO-MWCNTs, 1-AP-MWCNTs, and carbon black. The PtRu loading was 20 wt. %. In the case of 20% PtRu/AOMWCNTs, the dispersion of PtRu nanoparticles on MWCNTs is characterized by a poor distribution with a large number of aggregates (FIG. 21a). The average particle size of PtRu nanoparticles is 3±0.4 nm. For the MWCNTs functionalized by the acid oxidation treatment, the defects generated are usually not uniform. When PtRu nanoparticles are deposited on the MWCNTs, the particles tend to deposit on these localized defect sites, leading to poor dispersion and extensive aggregation. The extensive aggregation of PtRu electrocatalysts would lead to the reduced electrocatalytic activity of the PtRu electrocatalysts. In contrast, PtRu nanoparticles are evenly deposited on the 1-AP functionalized MWCNTs with no agglomeration (FIG. 21b). The average particle size is 2±0.2 nm, much smaller than that on the AO-MWCNTs. This clearly indicates that immobilization of 1-AP or any other polyelectrolyte mentioned herein on the sidewalls of MWCNTS produces a uniform distribution of the amino groups, which serve as functional groups for the self-assembly of Pt and Ru precursors on the surface of MWCNTs. Therefore, a much more uniform distribution of PtRu nanoparticles would be expected. The distribution of PtRu nanoparticles supported XC-72 carbon black is reasonable (FIG. 21c). This suggests that the good distribution and nanosized PtRu nanoparticles can be obtained by the microwave-assisted polyol method. The EDX spectrum of PtRu/1-AP-MWCNTs electro catalysts confirms that both Pt and Ru nanoparticles were successfully deposited on 1-AP-functionalized MWCNTs (FIG. 21d).

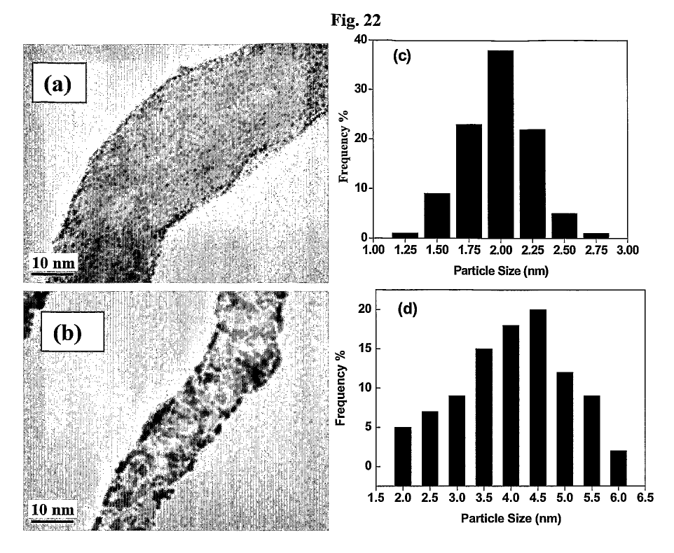

The PtRu loading on 1-AP-functionalized MWCNTs can be easily increased by proper control of the concentration of Pt and Ru precursors. FIG. 22a shows an example of a TEM micrograph of 40% PtRu/1-AP-MWCNTs. With the increase in the PtRu loading, a good dispersion is still maintained on the 1-AP functionalized MWCNTs without agglomeration (FIG. 22a). The histogram indicates that the distribution of the PtRu nanopartilces is very narrow and the average particle size is 2 nm, similar to that for 20% PtRu/1-AP-MWCNTs (FIG. 22b). On the other hand, for PtRu/AO-MWCNTs with 40 wt. % PtRu loading, the agglomeration problem became more serious (FIG. 22c). The histogram indicates that the distribution of the PtRu nanoparticles is broad, and the average diameter is about 4.3 nm (FIG. 22d), which is larger than that with 20 wt. % PtRu loading. The results are significant as not only uniformly distributed PtRu nanoparticles but also a high PtRu loading can be obtained on 1-AP-functionalized MWCNTs. The high loading and uniformity of PtRu nanoparticles on 1-AP-MWCNTs is clearly due to the immobilization of bifunctional molecules, 1-AP, which offers large and uniform distributed active sites for anchoring metal ions and metal nanoparticles. Thus, 1-AP-functionalized MWCNTs are far more effective supports than the conventional acid-oxidized MWCNTs.

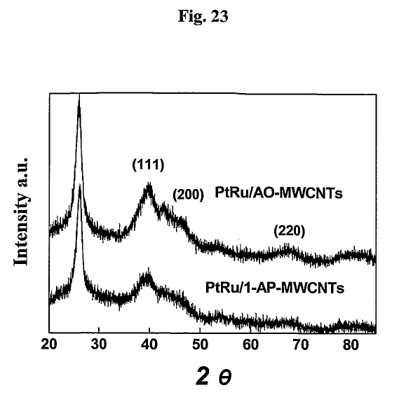

FIG. 23 shows the XRD patterns of PtRu nanoparticles deposited on AO-MWCNTs and 1-AP-MWCNTs with the 20 wt. % PtRu loading. The XRD results show the presence of diffraction peaks at 39.6°, 46.3°, 67.4°, which can be assigned to Pt(111), Pt(200), and Pt(220), consistent with the face-centered cubic (fcc) structure of platinum. PtRu alloys would take the face-centered cubic (fcc) structure of Pt if the Ru content is below 60 wt. %. The peak near 20 of 26°. originates from the graphitic carbon of MWCNTs. The Pt(220) bands at 67.4° are broader and weaker for PtRu/1-AP-MWCNTs-20 wt. % than that for PtRu/AO-MWCNTs-20 wt. %, indicating the smaller size of PtRu nanoparticles on 1-AP-functionalized MWCNTs. On the basis of Sherrer's equation through line broadening of the Pt(220) peak (see above equation), the average size of Pt nanoparticles for PtRu/1-AP-MWCNTs and PtRu/AO-MWCNTs was calculated as 2 and 3 nm, respectively. These values agree quite well with the TEM results. The electrocatalytic activity of the PtRu/1-AP-MWCNTs as potential electrocatalysts for the low-temperature fuel cells was examined.

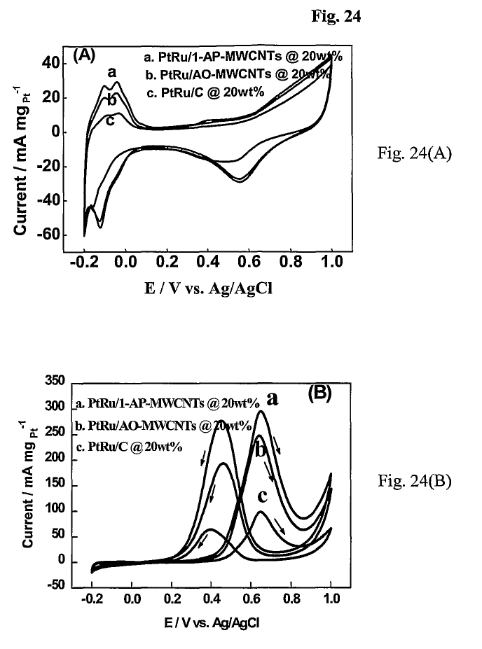

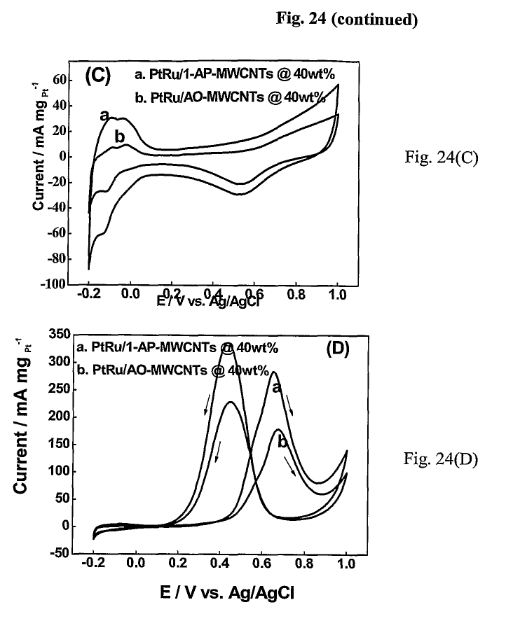

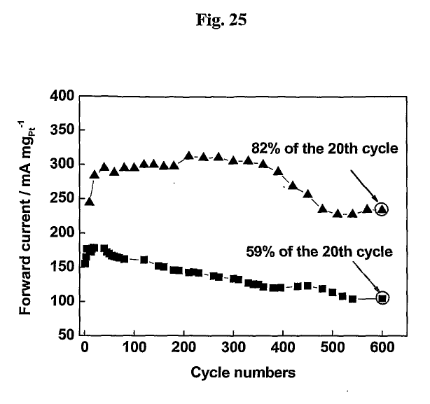

FIG. 24 shows the cyclic voltammograms (CVs) of PtRu/1-AP-MWCNTs and PtRu/AO-MWCNTs with different PtRu loadings measured in a nitrogen-saturated 0.5 M H₂SO₄ solution in the absence and presence of 1.0 M CH₃OH. For the purpose of comparison, the catalytic activity of carbon black (XC-72) supported PtRu catalysts was also investigated. The electrochemical surface area (ESA) of PtRu nanoparticles on MWCNTs and carbon black supports can be obtained from the area of the hydrogen desorption peak after correcting for the double layer charging current from the CVs measured in 0.5 M H₂SO₄ solutions (FIG. 24a, c), and the calculated ESA values are summarized in Table 2.

TABLE 2
Particle Size, Electrochemical Surface Area, Onset Potential,
and Forward Peak Current of Different PtRu Electrocatalysts
on 1-AP-MWCNTs, AO-MWCNTs, and CX-72-Carbon

| | Average | ECSA | Onset | Forward peak |
|---|---|---|---|---|
| | particle size | (cm²/mg | potential | current (mA/mg |
| Electrocatalyst | (nm) | Pt) | (V) | Pt) |
| PtRu/1-AP-MWCNTs-20 wt. % | 2 | 423 | 0.37 | 295.0 |
| PtRu/AO-MWCNTs-20 wt. % | 3 | 370.6 | 0.38 | 247.4 |
| PtRu/1-AP-MWCNTs-40 wt. % | 2 | 416 | 0.38 | 283.9 |
| PtRu/AO-MWCNTs-40 wt. % | 4.3 | 182 | 0.38 | 178.5 |
| PtRu/C-20 wt. % | 2 | 164.9 | 0.41 | 98.3 |

The ESA for the PtRu/1-AP-MWCNTs-20 wt. % is 423 cm²/mg of Pt, higher than 370.6 cm2/mg of Pt of PtRu/AO-MWCNTs-20 wt % and 164.9 cm²/mg of Pt of PtRu/C-20 wt. %, most likely due to the smaller size and much better dispersion of the PtRu nanoparticles on 1-AP-functionalized MWCNTs. This also demonstrates that the PtRu nanoparticles deposited on 1-AP-MWCNTs are electrochemically more accessible, which is very important for electrocatalyst applications in fuel cells. With further increase of PtRu loading to 40 wt. %, the ESA for PtRu/AO-MWCNTs is decreased 182 cm²/mg of Pt, a reduction in ESA by 51% as compared with the 20% PtRu/AO-MWCNTs. This can be attributed to the more serious agglomeration of PtRu on MWCNTs due to the increase of PtRu loading, which is also confirmed by the increase in the size of PtRu nanoparticles as the loading increased from 20% to 40% (Table 2). On the other hand, for PtRu/1-AP-MWCNTs with 40 wt. % loading, the ESA is 416 cm²/mg of Pt, very close to 423 cm²/mg of Pt for 20% PtRu/1-AP-MWCNTs. This is because the uniform distribution of PtRu nanoparticles on 1-AP-MWCNTs is still maintained, even at a high loading. The high electrochemical active area for the PtRu/1-APMWCNTs with different PtRu loading on MWCNTs is also supported by the high electrocatalytic activity for the electrooxidation reaction of methanol (FIG. 24B, D). The Faradic current for the reaction in nitrogen-saturated 0.5 M H₂SO₄+1.0 M CH₃OH solution exhibits the well-known features of methanol oxidation on Pt-based electrocatalysts. The forward oxidation current peak occurs at 0.65 V and the backward oxidation current peak at 0.46 V, which are close to that reported in the literature. The activity of PtRu electrocatalysts for the methanol oxidation can be represented by the magnitude of the forward anodic current peak. The forward peak current density normalized by Pt loading on GCE for the methanol oxidation reaction on MWCNTs with different PtRu loadings and carbon black are also given in Table 2. In the case of 20 wt. % PtRu loading, as shown in FIG. 24b, the significantly higher anodic current for the reaction on PtRu/1-AP-MWCNTs and PtRu/AOMWCNTs indicates a much higher electrocatalytic activity of MWCNT-supported PtRu electrocatalysts than the carbonsupported PtRu electrocatalysts. The higher electrocatalytic activity for the methanol oxidation on PtRu/1-AP-MWCNTs-20 wt. % than that on PtRu/AO-MWCNTs-20.wt % again shows the importance of the distribution and dispersion of PtRu electrocatalysts on MWCNTsupports, in agreement with the high electrochemically active surface area of PtRu/1-AP-MWCNTs. With the increase of PtRu loading to 40 wt. % on MWCNTs, the forward peak current density for the PtRu/AO-MWCNTs is 178.5 mA/mg Pt, a decrease by 28% in comparison with 247.4 mA/mg Pt for the reaction on 20% PtRu/AO-MWCNTs. The significant decrease in anodic current density is most likely due to the increased size of PtRu nanoparticles on AOMWCNTs with the increase of the PtRu loading. For PtRu/1-AP-MWCNTs-40 wt. %, the decrease in the anodic current density is only 3.8% as compared to that on 20% PtRu/1-AP-MWCNTs, which is significantly smaller than the 28% in the case of AO-MWCNTs supports. This is consistent with the ESA results.

For practical fuel cells applications, in order to reduce the thickness of the catalytic layer and thus facilitate the mass transport within catalytic layer, the high PtRu loading on supports is essential. At the same high PtRu loading (40 wt. %), PtRu/1-AP-MWCNTs shows much higher electrochemical surface area than PtRu/AO-MWCNTs. On the other hand, the onset potentials for methanol oxidation on PtRu/1-AP-MWCNTs and PtRu/AO-MWCNTs are similar, but slightly lower than that on PtRu/C (Table 2). The long-term stability of the PtRu electrocatalysts is very important for the development of commercially viable DMFCs. The forward peak currents on PtRu/1-AP-MWCNTs and PtRu/AO-MWCNTs were measured as a function of the number of cycles performed from −0.2 to 1.0 V in 0.5 M H₂SO₄+1.0 M MeOH, and the results are shown in FIG. 25. For PtRu electrocatalysts on MWCNTs,the forward peak density increases initially. In the case of PtRu/1-AP-MWCNTs, the peak current remains almost constant from the 40^{th} cycle to the 350^{th} cycle after the initial increase. The peak current starts to decrease gradually after the 350 cycles of potential scan. Using the current density measured after the 20^{th} cycle as the reference, the anodic peak current of the 600^{th} cycle is about 82% of that measured at the 20^{th} cycle. The reduction in the electrocatalytic activity for the methanol electrooxidation on PtRu/1-AP-MWCNTs is ˜18%. In the case PtRu/AO-MWCNTs, a poorer stability was observed. The peak current starts to decrease quickly after about 50 cycles. The peak current of the 600^{th} cycle is ˜59% of the current density measured at the 20^{th} cycle. In general, the gradual decrease of the catalytic activity after successive cycles of potential scan could result from the consumption of methanol during the electrochemical oxidation reaction.

However, the effect of the microstructural change of the PtRu nanoparticles caused by the perturbation of the potentials on the electrocatalytic activity can be substantial. The high anodic peak currents and much slower degradation in the anodic peak currents for the reaction on PtRu/1-AP-MWCNTs as compared to that on PtRu/AO-MWCNTs demonstrate the significantly enhanced activity and stability of PtRu electrocatalysts on 1-AP-MWCNTs. The increased stability also indicates that the attachment of PtRu on MWCNTs via 1-AP as interlinkers is strong. The results demonstrate the suitability of noncovalent functionalization of MWCNTs by 1-AP as highly efficient and effective catalyst supports, especially for the development of PtRu electrocatalysts with high loading for the methanol electrooxidation in DMFCs.

6. Manufacture of Metal Coated Nanostructured Material

The following method describes at first the manufacture of Pt-PDDA-MWCNTs, i.e. the manufacture of a metal loaded nanostructured material, and in addition the manufacture of a metal coated nanostructured material, namely Pt-PDDA-MWCNTs covered with a noble metal film or sheath.

The manufacture of PDDA-MWCNTs is carried out as described above under Example 1.

After the manufacture of PDDA-MWCNTs, for in situ deposition of Pt metal, the PDDA coated tubes (30 mg) were mixed ultrasonically with H₂PtCl₆ (sufficient for a Pt loading of 50 wt %) in ethylene glycol (EG) after which the pH was adjusted to 12.5 by adding NaOH (2.5 M) dropwise. Reduction of platinum was driven to completion by treatment in a domestic microwave oven (120 s), after which the solution was acidified with HCl (1 M) (pH 3-4) to promote the deposition of metal. The product was collected by filtration using a nylon membrane and washed several times with water before vacuum drying (70° C./24 hr).

The experimental procedure for sheathing the Pt-seeded MWCNTs, i.e. coating the nanostructured material obtained, inyolved: (i) ultrasonically dispersing Pt/PDDA-MWCNTs-50 wt % (10 mg) in DI-water (50 ml) for 30 min with boiling; (ii) ascorbic acid (AA) was introduced as the reducing agent and boiling continued for 10 min; (iii) aqueous H₂PtCl₆ (3 mL, 11 mM,) was added dropwise such that the AA:H₂PtCl₆ molar ration was 5:1, to ensure that excess AA drove metal reduction to completion. The metal precursor is added slowly to guarantee the formation of contiguous nanosheaths on MWCNTs; and (iv) boiling continued (30 min) to complete metallization before cooling to ambient.

The product was collected by nylon membrane filtration and vacuum dried (70° C./overnight). The Pt sheath thickness was controlled by adjusting the volume of H₂PtCl₆ (3, 8 and 12 mL). The synthesis procedures of Pd and Au nanosheaths were similar to Pt. For Pd nanosheaths, Pt/PDDA-MWCNTs (10 mg) and PdCl₂ (17.9 mL/10 mM) were used, while for Au nanosheaths HAuCl₄ (4.6 mL/20 mM) was added and reduction driven to completion with AA (10 mg). The mole ratios of AA to PdCl₂ or HAuCl₄ were 5:1.

The ionic functionalization of MWCNTs by coating with PDDA yields a large number of evenly distributed active sites on the MWCNT surfaces for anchoring anionic metal complexes and particles to the positively charged polymeric chains that results in homogeneously dispersed Pt crystallites (FIG. 3a). The distribution of Pt seeds on PDDA-MCNTs is uniform and narrow and the average particle size is 2±0.75 nm (the inset in FIG. 3a). Such an architecture proves ideal for the nucleation of contiguous, porous and crystalline noble metal nanosheaths (FIG. 3b). The Pt nanosheaths consist of Pt nanoparticles and the Pt crystallite size in the Pt nanosheaths is ˜3 nm (FIG. 3c). However, without the mediation of Pt seeds on the MWCNTs disconnected platinum aggregates form (FIG. 3d), as a result of solution nucleation and Ostwald ripening.

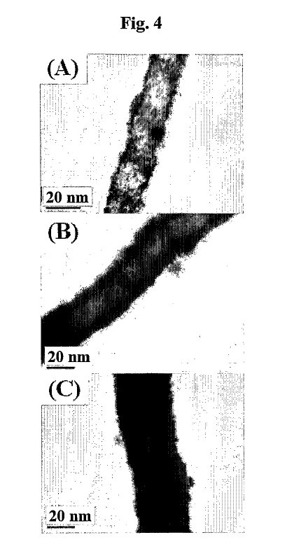

The Pt nanclusters vary from 10 nm to 50 nm. Distribution of Pt nanoclusters on MWCNTs is very poor. Hence, seeding is a necessary prerequisite for successful Pt sheathing. Thin Pt nanosheaths were formed on MWCNTs when 3 mL H₂PtCl₆ was used, and gradually thickened as the amount of salt increased to 12 mL (FIG. 4). This corresponds to a Pt loading of 69.6%, 81.6%, 86 wt % synthesized with the addition of 3, 8 and 12 mL H₂PtCl₆ solution in the reactor. For the thick nanosheaths the MWCNTs are completely obscured in TEM images (FIG. 4c).

This metal seed-mediated method is readily extended to the preparation of Pd nanosheaths (FIG. 5(A)). Again, in the absence of Pt seeds, isolated Pd aggregates were obtained (FIG. 5(B)), as Pd ions would preferentially nucleate in solution. Distribution of Pd nanoclusters on MWCNTs is also very poor. For thick (over)layers EDS yielded molar ratios of Pd:Pt of ˜7:1 as expected from the feed ratio. X-ray mapping and lattice imaging confirmed that Pd was uniformly distributed over the MWCNT surfaces to an overall diameter of ˜45 nm (FIG. 5(C)). The Pt is uniformly along the MWCNT and the diameter of the Pt seeds-mediated MWCNTs is ˜21 nm (FIG. 5(D)). It can be seen that the density of Pd is apparently higher than that of Pt, indicating the formation of dense Pd nanosheaths.

The thickness of the Pd nanosheaths can be obtained by halving the difference between the diameters of the cross-section, which is 12 nm in this case. HRTEM readily differentiate the Pd sheath from MWCNT template due to the different contrast of inner MWCNT supports and outer Pd nanosheaths (FIG. 5(E)). The diameter of the Pd nanosheaths on MWCNT is ˜45 nm, while the diameter of the inner MWCNT is 21 nm, which are consistent with the observation by the EDS mapping analysis. Owing to the different brightness in the HRTEM (High-resolution transmission electron microscopy) images, we can conclude the Pd nanosheaths also consist of Pd nanoparticles, marked with dotted circles in FIG. 5(F). The lattice fringes display the polycrystalline nature of the Pd nanosheaths and the average size of the Pd nanopartices in Pd nanosheaths is ˜10 nm.

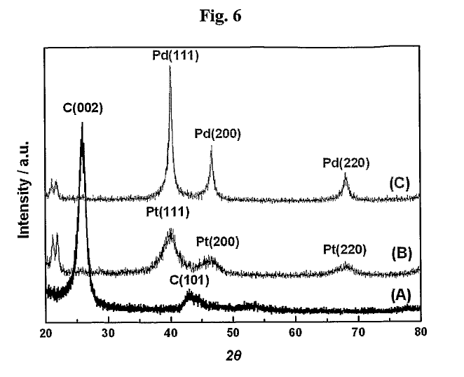

XRD confirmed the crystalline nature of the Pd and Pt nanosheaths (FIG. 6). For pure MWCNTs, a strong diffraction peak at ˜26° can be attributed to the graphite-like wall structure, that upon coating with Pt or Pd splits into two reflections and moves to smaller diffraction angles showing the graphitic layers of the template are pushed closer together. For the thick nanosheaths, X-ray diffraction from the nanotube templates is obstructed. Based on the Scherrer equation and line broadening of the Pt(220) peak, the average size of Pt nanoparticles in the nanosheaths can be calculated as ˜3 nm. This is similar to that observed by TEM (FIG. 3c). Similarly, the average size of Pd crystallites based on the Pd(220) peak was calculated as ˜10 nm in agreement with HRTEM observations (FIG. 5f).

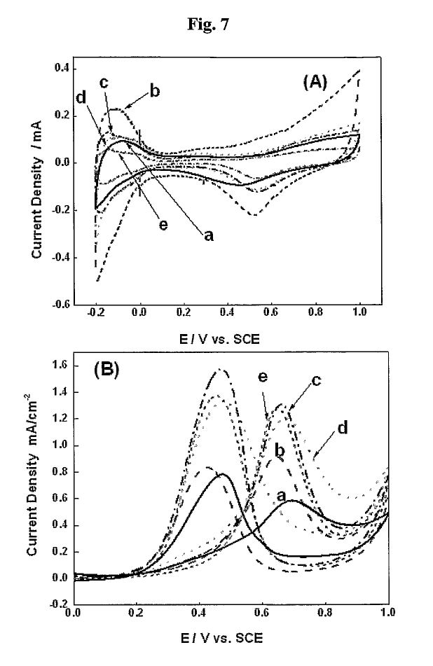

To demonstrate the electrocatalytic activity of noble metal (Pt and Pd) nanosheaths, it was studied the electrocatalytic activity of Pt nanosheaths on MWCNTs with different thickness (i.e., different Pt loadings) for the electrooxidation reaction of methanol of direct methanol fuel cells. Cyclic voltammetry (CV) curves were collected in 0.5 M H₂SO₄ with the absence and the presence of 0.5 M methanol and the results are shown in FIG. 7. The measurements of the electrocatalytic activity of the Pt electrocatalysts were carried out using a glass carbon electrode (GCE) and Pt loading on the GCE was kept constant at 0.015 mg. A saturated calomel electrode (SCE) was used as the reference electrode. The electrochemically active surface area (ECSA) was calculated from the CV curves collected in 0.5 M H₂SO₄ in the absence of methanol (FIG. 7a). The obtained ECSA was used to normalize the CVs of the methanol oxidation on Pt nanosheath electrocatalysts. As shown, the current exhibits the well-known features of methanol oxidation on Pt-based electrocatalysts (FIG. 7b). Pt nanosheaths supported on MWCNTs with 50 wt % Pt loading show significantly higher ECSA and higher electrocatalytic activity for the methanol oxidation than the commercial E-TEK Pt/C (50 wt. % Pt) electrocatalysts. This is apparently due to the uniform distribution and small size of Pt nanoparticles in the Pt nanosheaths on PDDA-MWCNTs supports. This also demonstrates that the Pt nanosheaths on PDDA-MWCNTs are electrochemically accessible. The electrocatalytic activity of Pt nanosheaths increases with the increase of the thickness (i.e., the loading) of Pt nanosheths. The enhanced activity for the methanol oxidation on Pt nanosheaths on MWCNTs could also be attributed to the high electrical conductivity along the carbon nanotubes. As shown in FIG. 4, the one-dimensional tubular structures of Pt nanosheaths were already formed even at 69.6 wt. % Pt loading. Further growth in the Pt nanosheath would simply increase the thickness of the Pt nanosheath. This is probably the main reason for the closeness of the electrocatalytic activity of the Pt nanosheaths on MWCNTs with the Pt loadings higher than 69.6 wt. %. However, the thickness and density of the one-dimensional nanosheaths could be critical for the catalysts and sensor applications in optical, biological and electronic devices.

The method of manufacturing metal coated nanostructured material provides a simple route to fabricate metal nanosheaths on 1D tubular templates and may prove especially useful in energy and environmental applications requiring low temperature catalysis either to destroy pollutants or for the green synthesis of chemicals.

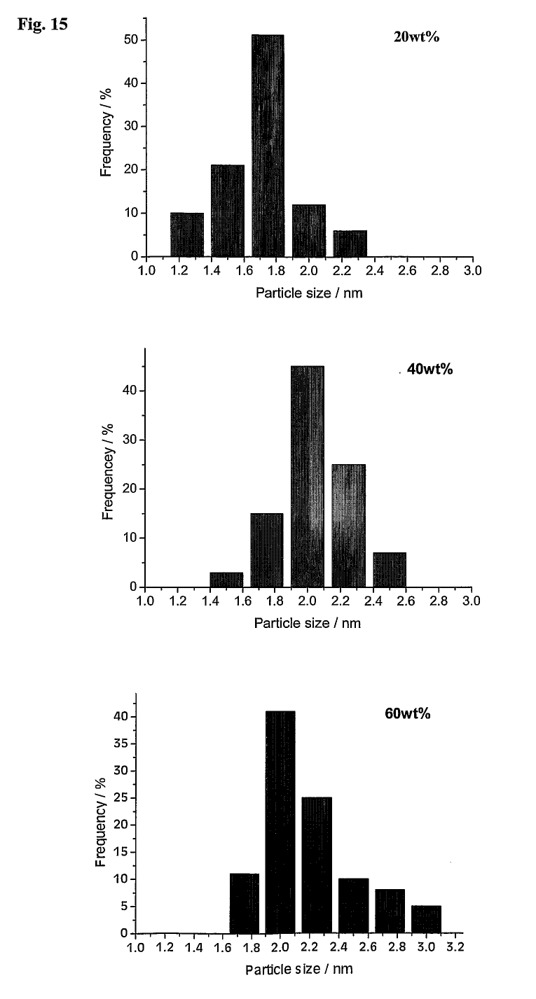

FIG. 15 shows histograms illustrating the Pt nanoparticles size distribution on CNT. From this FIG. 15, one can see that the particle size distribution is very narrow; and although the average particle size slightly increases with the increase of Pt loading, the increase step is very small.

FIG. 16 illustrates how much the particle size obtained by the present method can be reduced when using a microwave heating procedure. The microwave heating procedure can accelerate the reaction rate, which thus leads to smaller particle size, for example, as shown in FIG. 16. The average size of Pt particles shown in FIG. 16 is about 1.6 nm.

7. Use of Different Polyelectrolytes for Coating CNTs and Loading them with Pt

The use of different polyelectrolytes for functionalizing MWCNT and their effect on the electrocatalytic activity and stability in fuel cells has been investigated. Four different polyelectrolytes, PDDA, PAH, PAA and PSS have been chosen. PDDA and PAH are positively charged polyelectrolytes, and PAA and PSS are negatively charged polyelectrolytes.

Experimentally, polyelectrolytes are first wrapped around MWCNT following the procedure as described previously. Once the polyelectrolyte wrapped MWCNT powder (see Example 1) is obtained, it was mixed with Pt precursors (the amount of Pt precursors was controlled by the fixed loading of Pt on MWCNT at 10 wt. %) in EG. The mixture was sonicated for 30 min to disperse the suspension, and then the pH was adjusted to 12. After that the suspension was placed in a house-hold microwave oven to heat the suspension for 1 min. Then the pH of the solution was adjusted back to 3-4, and keep the stirring for 3 hours, followed by filtration and drying in vacuum oven for 7 hours. The catalysts are denoted as Pt/PDDA-CNT, Pt/PAH-CNT, Pt/PAA-CNT, Pt/PSS-CNT, respectively. Their TEM images are shown in FIG. 17. From FIG. 17 it can be seen that the four different polyelectrolytes do not significantly affect the morphology of Pt/CNT composite.

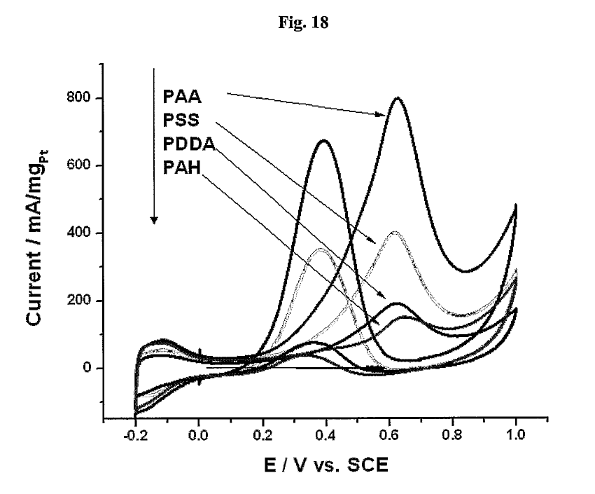

The electrochemical catalytic activity of the Pt/MWCNT electrocatalysts shown in FIG. 17 was measured for methanol oxidation reaction in acid medium. The following CV diagram (FIG. 18) shows their mass activity for methanol oxidation. As shown, the Faradaic current exhibits the well-known features of methanol oxidation on Pt based catalyst. As a kinetically controlled reaction, the activity of methanol oxidation on Pt can be represented by the magnitude of the anodic peak. The higher anodic current indicates a higher electro-catalytic activity on Pt/MWCNTs.

The results show that all polyelectrolyte materials are suitable. However, PAA- and PSS-functionalized MWCNT as Pt support show much higher current density, compared with PDDA- and PAH-functionalized ones. The electrochemical characterization results were collected in nitrogen purged 0.5 M H₂SO₄+1.0 M CH₃OH solutions at room temperature. The curves are normalized based on the Pt weight on glassy carbon electrode. The scan rate is 50 mV/s.

1. A method of manufacturing a metal loaded nanostructured material, wherein the method comprises:
reacting an unoxidized nanostructured material and a polyelectrolyte in a dispersion of the untreated nanostructured material and the polyelectrolyte;
dispersing the reacted nanostructured material obtained in the previous step and a noble metal precursor in a solution comprising a suitable reducing agent under conditions allowing reducing and depositing of the noble metal precursor on the reacted nanostructured material to obtain a nanostructured material loaded with metal particles.

2. The method according to claim 1, wherein the conditions for reducing and depositing include adjusting the pH to between about 8 to 12.

3. The method according to claim 1 or 2, further comprising refluxing the solution.

4. The method according to claim 2 or 3, further including adjusting the pH to acidic conditions.

5. The method according to claim 4, wherein the pH is adjusted to between about 3 to 5 or 3 to 4.

6. The method according to claim 1 or 2, wherein the conditions for reducing and depositing further include subjecting the solution to electromagnetic waves with wavelengths ranging from 1 mm to 1 m.

7. The method according to claim 6, wherein the subjecting to the electromagnetic waves is carried out between about 1 to 3 min.

8. The method according to any of the preceding claims, further comprising adding an inorganic salt to the dispersion of the unoxidized nanostructured material and the polyelectrolyte.

9. The method according to claim 8, wherein the inorganic salt is comprised in the dispersion of the unoxidized nanostructured material and the polyelectrolyte in a concentration of less than 1 wt % based on the total amount of the dispersion.

10. The method according to any of the preceding claims, wherein the reduction potential (E⁰/V) of the reducing agent is between about 1.0 V to about 0.0 V.

11. The method according to any of the preceding claims, wherein the reducing agent is added together with a stabilizer.

12. The method according to any of claims 1 to 9 and 11, wherein the reducing agent is selected from the group consisting of ascorbic acid, boranes, copper hydride, citric acid, diisobutylaluminium hydride (DIBAL-H), diethyl 1,4-dihydro-2,6-dimethyl-3,5-pyridinedicarboxylate, ethanol, ethyleneglycol (EG), formaldehyde, formic acid, hydrazine, hydrogen, lithium aluminum hydride (LiAlH₄), 3-mercaptopropionic acid (3-MPA), methanol, nickel borohydride, silane, isopropanol (2-propanol), sodium bis(2-methoxyethoxy)aluminumhydride (Red-Al), sodium hydroxymethanesulfinate (Rongalite), sodium borohydride (NaBH₄), sodium cyanoborohydride, sodium dithionite (Na₂S₂O₄), sodium triacetoxyborohydride, tetramethyldisiloxane (TMDSO, TMDS), tributyltin hydride (tributylstannane), triphenylphosphine and triphenylphosphite.

13. The method according to any of claims 1 to 12, wherein the nanostructured material is selected from the group consisting of spheres, cubes, nanotubes, nanowires (also called nanofibers), nanorods, nanoflakes, nanoparticles, nanodiscs, nanofilms and combinations of the aforementioned nanostructured materials in a mixture.

14. The method according to claim 13, wherein said nanotubes are single-walled or double-walled or multi-walled nanotubes.

15. The method according to any of claims 1 to 14, wherein at least one dimension of the nanostructured material is less than 100 nm.

16. The method according to any of claims 1 to 15, wherein said nanostructured material is made of carbon material.

17. The method according to claim 16, wherein said carbon material is selected from the group consisting of activated carbon, carbon blacks and graphite.

18. The method according to any of the preceding claims, wherein the noble metal is selected from the group consisting of ruthenium, rhodium, gold, platinum, palladium, osmium, iridium and alloys of the aforementioned noble metals.

19. The method according to claim 18, wherein the alloy is an alloy of Au, or Pt, or Pd, or Cu, or In, or InSe, or PtRu or CuSe, or SnS₂ or mixtures thereof, or Ag₂Ni.

20. The method according to any of the preceding claims, wherein the noble metal precursor is selected from the group consisting of AgNO₃, [Ag(NH₃)₂]⁺ (aq), HAuCl₄.3H₂O, H₂PtCl₆.6H₂O, PdCl₂, K₂PdCl₄, RuCl₃, H₂PdCl₆.6H₂O and mixtures thereof.

21. The method according to any of the preceding claims, wherein the polyelectrolyte is a positively charged polyelectrolyte or negatively charged polyelectrolyte.

22. The method according to claim 21, wherein the positively charged polyelectrolyte is selected from the group consisting of naturally occurring polyelectrolytes, polyelectrolytes comprising a quaternary ammonium group and copolymers thereof; polyelectrolytes comprising a pyridinium group and copolymers thereof, and protonated polyamines.

23. The method according to claim 21, wherein the negatively charged polyelectrolyte is selected from the group consisting of naturally occurring polyelectrolytes, polyelectrolytes comprising a sulfonate group (SO₃⁻) their salts, and copolymers thereof; polycarboxylates and sulfates (SO₄²⁻).

24. The method according to claim to any of claims 1 to 20, wherein the polyelectrolyte is selected from the group consisting of 1-aminopyrene (1-AP), poly(diallyldimethylammonium chloride (PDDA), poly(styrenesulfonic acid) (PSS), poly(acrylic acid) (PAA) and poly(allylaminehydrochloride) (PAH).

25. The method according to any of the preceding claims, further comprising:
dispersing and heating a metal particle coated nanostructured material according to any of claims 1 to 24 in a solution;
adding a reducing agent and continuing heating;
adding a solution comprising a second noble metal precursor or metal oxide to the heated dispersion, wherein said second noble metal precursor or metal oxide is added sequentially; and
heating the dispersion for a time suitable to form a metal film at the surface of the metal particle loaded nanostructured material.

26. The method according to claim 25, comprising varying the thickness of the metal film by varying the total amount of noble metal precursor or metal oxide.

27. The method according to claim 25 or 26, wherein the molar ratio of reducing agent to the second noble metal precursor or metal oxide is between about 1:1 to 10:1.

28. The method according to claim 27, wherein the molar ration is 4:1 or 5:1.

29. The method according to any of claims 25 to 28, wherein the second noble metal of the second noble metal precursor is selected from a noble metal as defined in claim 17.

30. The method according to any of claims 28 to 29, wherein the second noble metal precursor is the same as or different from the noble metal precursor used in claim 1.

31. The method according to any of claims 25 to 30, wherein the metal oxide is selected from the group consisting of The method according to any of the preceding claims, wherein the metal oxide is selected from the group consisting of Ag—MnO₂, Al₂O₃, MoO₃, MnO₂, V₂O₅, TiO₂, SiO₂, ZnO₂, SnO₂, Fe₂O₃, NiO, Co₃O₄, CoO, Nb₂O₅, W₂O₃, and mixtures thereof; wherein said metal oxide can be either stoichiometric or non-stoichiometric (e.g. Meₙ₋ₓO_{m-y}, 0<x<1;0<y<1; 1≦n≦3; 1≦m≦5).

32. A nanostructured material loaded with noble metal particles;
wherein a polyelectrolyte is bound to the nanostructured material;
wherein the noble metal particles are bound to the polyelectrolyte;
wherein the particles have a size of between about 1 to 10 nm.

33. The nanostructured material of claim 32, wherein the particles do not form particle aggregates.

34. A nanostructured material made of a carbon material covered with a layer of a noble metal or a metal oxide.

35. The nanostructured material of claim 34, wherein the layer is between about 4 to 20 nm thick.

36. An electrode comprising a nanostructured material obtained by a method according to any of claims 1 to 31 or a nanostructured material according to any of claims 32 to 35.

37. A method of manufacturing an electrode comprising forming the nanostructured material obtained by a method according to any of claims 1 to 31 or a nanostructured material according to any of claims 32 to 35 into a membrane.

38. Use of a nanostructured material obtained by a method according to any of claims 1 to 31 or a nanostructured material as described in any of claims 32 to 37 for an electrode.
